(19) United States
(12) Patent Application Publication
(10) Pub. No.: US 2026/0252019 A1
(43) Pub. Date: Aug. 27, 2026

(54) SHEET PROCESSING APPARATUS, IMAGE FORMING SYSTEM, AND NON-TRANSITORY RECORDING MEDIUM

(71) Applicants: Shuuto TOHKAISHI, Kanagawa (JP); Yuusuke SHIBASAKI, Tokyo (JP); Tomomichi HOSHINO, Kanagawa (JP); Wataru TAKAHASHI, Tokyo (JP); Sho ASANO, Kanagawa (JP); Atsushi SHINODA, Kanagawa (JP); Shota YOSHIDA, Kanagawa (JP); Kotomi KAMEYAMA, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(72) Inventors: Shuuto TOHKAISHI, Kanagawa (JP); Yuusuke SHIBASAKI, Tokyo (JP); Tomomichi HOSHINO, Kanagawa (JP); Wataru TAKAHASHI, Tokyo (JP); Sho ASANO, Kanagawa (JP); Atsushi SHINODA, Kanagawa (JP); Shota YOSHIDA, Kanagawa (JP); Kotomi KAMEYAMA, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(73) Assignee: ETRIA CO., LTD., Yokohama-shi (JP)

(21) Appl. No.: 19/541,873

(22) Filed: Feb. 17, 2026

(30) Foreign Application Priority Data
Feb. 21, 2025 (JP) 2025-027179

(51) Int. Cl. G03G 15/00

(52) U.S. Cl. CPC G03G 15/6544; G03G 15/5012

(57) ABSTRACT

A sheet processing apparatus includes a temporary stacker on which a plurality of sheets are stacked on a temporary basis, a sheet processing device to perform given processing on a sheet bundle including the plurality of sheets stacked on the temporary stacker, an ejection device including a pair of rotors to eject the sheet bundle, and a guide to move between a first position above a top face of lower one of the pair of rotors and a second position below the top face of the lower one of the pair of rotors.

### CROSS-REFERENCE TO RELATED APPLICATION

This patent application is based on and claims priority pursuant to 35 U.S.C. § 119(a) to Japanese Patent Application No. 2025-027179, filed on Feb. 21, 2025, the Japan Patent Office, the entire disclosure of which is hereby incorporated by reference herein.

### BACKGROUND

### Technical Field

The present disclosure relates to a sheet processing apparatus, an image forming system, and a non-transitory recording medium storing a program.

### Background Art

Sheet processing apparatuses have been proposed that can perform so-called manual binding to bind a sheet bundle inserted through an opening. For example, when sheets of paper are inserted, an output tray is located at a position higher than an internal tray.

### SUMMARY

The present disclosure described herein provides a sheet processing apparatus, an image forming system, and a non-transitory recording medium storing a program. The sheet processing apparatus includes a temporary stacker on which a plurality of sheets are stacked on a temporary basis, a sheet processing device to perform given processing on a sheet bundle including the plurality of sheets stacked on the temporary stacker, an ejection device including a pair of rotors to eject the sheet bundle, and a guide to move between a first position above a top face of lower one of the pair of rotors and a second position below the top face of the lower one of the pair of rotors. The image forming system includes an image forming device to form an image on a sheet, the sheet processing apparatus on which the sheet that has passed through the image forming device is stacked to perform given processing on the sheet, a sheet ejection unit including a pair of rotors to eject the sheet processed by the sheet processing apparatus, a guide to move to a first position above a top face of lower one of the pair of rotors and a second position below the top face of the lower one of the pair of rotors, and processing circuitry to send an instruction to stop an image-forming operation by the image forming device or an instruction to stop conveying the sheet to the sheet processing apparatus when the guide is at the first position and an instruction to execute the image-forming operation by the image forming device is given. The non-transitory recording medium stores a plurality of instructions which, when executed by one or more processors of the sheet processing apparatus, causes the one or more processors to perform a method, and the method includes terminating an image-forming operation or conveyance to the sheet processing apparatus when the guide is at the first position and instructions are given to execute the image-forming operation by the image forming device.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating an internal structure of an image forming system.

FIG. 2 is another diagram illustrating an internal structure of an image forming system.

FIG. 3 is a block diagram illustrating a hardware configuration of an image forming system.

FIG. 4 is another block diagram illustrating a hardware configuration of an image forming system.

FIG. 5 is a diagram illustrating an internal structure of a sheet processing apparatus.

FIG. 6A and FIG. 6B are diagrams each of which illustrates a step of the operation of a sheet processing apparatus.

FIG. 7A and FIG. 7B are diagrams each of which illustrates a step of the operation of a sheet processing apparatus.

FIG. 8 is a diagram illustrating a step of the operation of a sheet processing apparatus.

FIG. 9A and FIG. 9B are diagrams each of which illustrates a step of the operation of a sheet processing apparatus.

FIG. 10A and FIG. 10B are diagrams each of which illustrates a step of the operation of a sheet processing apparatus.

FIG. 11 is a diagram illustrating a sheet processing apparatus according to a comparative example.

FIG. 12 is a diagram illustrating a sheet processing apparatus according to a comparative example.

FIG. 13A and FIG. 13B are diagrams each of which illustrates a guide provided for a sheet processing apparatus, according to a first example.

FIG. 14A and FIG. 14B are diagrams each of which illustrates a guide provided for a sheet processing apparatus, according to a first example.

FIG. 15 is a diagram illustrating a guide provided for a sheet processing apparatus, according to a first example.

FIG. 16A and FIG. 16B are diagrams each of which illustrates a guide provided for a sheet processing apparatus, according to a second example.

FIG. 17 is a diagram illustrating a guide provided for a sheet processing apparatus, according to the second example.

FIG. 18 is a diagram illustrating a lifting and lowering mechanism for a guide.

FIG. 19 is another diagram illustrating a lifting and lowering mechanism for a guide.

FIG. 20 is still another diagram illustrating a lifting and lowering mechanism for a guide.

FIG. 21 is still another diagram illustrating a lifting and lowering mechanism for a guide.

FIG. 22 is a diagram illustrating a lifting and lowering movement of a guide.

FIG. 23 is another diagram illustrating a lifting and lowering movement of a guide.

FIG. 24A and FIG. 24B are other diagrams illustrating a lifting and lowering movement of a guide.

FIG. 25A and FIG. 25B are diagrams illustrating how manual binding is performed by a sheet processing apparatus.

FIG. 26 is a diagram illustrating how manual binding is performed by a sheet processing apparatus.

FIG. 27A and FIG. 27B are diagrams illustrating a guide provided for a sheet processing apparatus, according to a third example.

FIG. 28A and FIG. 28B are diagrams illustrating a guide provided for a sheet processing apparatus, according to a fourth example.

FIG. 29A and FIG. 29B are other diagrams illustrating a guide provided for a sheet processing apparatus, according to the fourth example.

FIG. 30 is a diagram illustrating a guide provided for a sheet processing apparatus, according to a fifth example.

FIG. 31 is another diagram illustrating a guide provided for a sheet processing apparatus, according to the fifth example.

FIG. 32 is still another diagram illustrating a guide provided for a sheet processing apparatus, according to the fifth example.

FIG. 33 is a diagram illustrating a guide provided for a sheet processing apparatus, according to a sixth example.

FIG. 34 is another diagram illustrating a guide provided for a sheet processing apparatus, according to the sixth example.

FIG. 35A and FIG. 35B is a diagram illustrating a guide provided for a sheet processing apparatus, according to a seventh example.

FIG. 36 is a diagram illustrating operations of a program executable by a sheet processing apparatus.

FIG. 37 is another diagram illustrating operations of a program executable by a sheet processing apparatus.

FIG. 38 is still another diagram illustrating operations of a program executable by a sheet processing apparatus.

FIG. 39 is still another diagram illustrating operations of a program executable by a sheet processing apparatus.

FIG. 40 is still another diagram illustrating operations of a program executable by a sheet processing apparatus.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, in a medium processing apparatus to which a bundle of sheets is manually fed through an ejection port for manual binding, the bundle of sheets can be inserted through the ejection port with greater customer convenience.

A sheet processing apparatus, an image forming system, and a non-transitory recording medium storing a program are described below with reference to the accompanying drawings.

### FIRST EMBODIMENT OF IMAGE FORMING SYSTEM

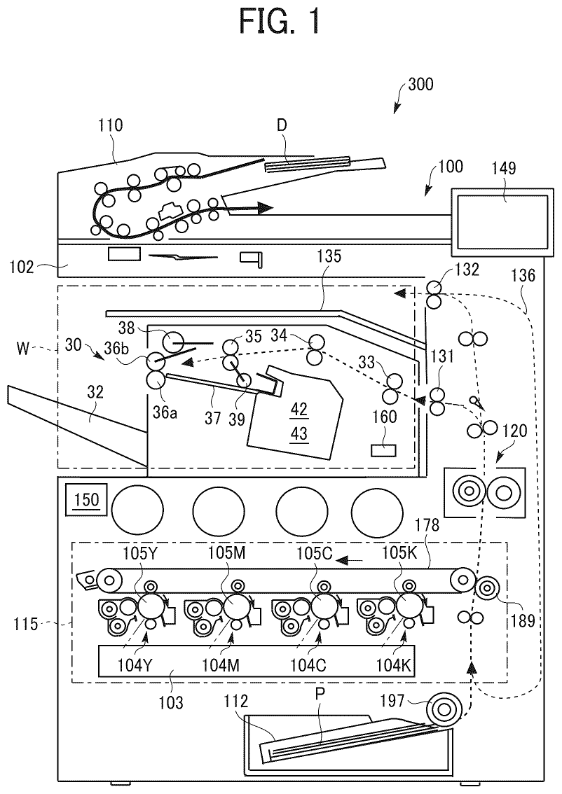

FIG. 1 is a diagram illustrating an internal structure of an image forming system 300.

As illustrated in FIG. 1, in the image forming system 300, a post-processing apparatus 30 is installed in an in-body space W of an image forming apparatus 100 in a detachable manner. The post-processing apparatus 30 is an example of a sheet processing apparatus. As will be described later in detail, the post-processing apparatus 30, which is an example of the sheet processing apparatus, has a function such as a binding function to be executed after an image is formed.

The in-body space W is formed between the document reading device 102 and the image forming device 115, and the in-body space W is a space to which a sheet P (sheet subjected to a print job) ejected from the image forming apparatus 100 can be ejected. The in-body space W is also a space from which the sheet P ejected from the image forming apparatus 100 can be taken out or picked up. In other words, when the post-processing apparatus 30 is not installed in the image forming apparatus 100, the in-body space W serves as a space or output unit in which the sheet P is or multiple sheets P ejected from the image forming apparatus 100 are stacked.

In the image forming system 300, the image forming apparatus 100 includes the elements other than the post-processing apparatus 30. Typically, the image forming apparatus 100 is provided with, for example, the image forming device 115, a feed tray 112, a fixing device 120, a document conveying device 110, and the document reading device 102. The image forming apparatus 100 or the image forming system 300 has an exterior provided with the operation panel 149 that displays various kinds of information and inputs various kinds of commands for the image forming system 300.

The post-processing apparatus 30, which is an example of a sheet processing apparatus, is provided with, for example, a crimp binding device 42 having a stapleless binding function, a stapler 43 having a stapling function, an internal tray 37 that is an example of a sheet stacker, a tapping roller 38, a second output tray 32 that is one of the output trays and is an example of a sheet-bundle stacker on which the sheet bundle PT is stacked, and a plurality of conveyance roller pairs 33, 34, 35, and 36. The post-processing apparatus 30 is located downstream from the image forming apparatus 100 in the sheet conveyance direction (a direction in which the sheet P is conveyed). The post-processing apparatus 30 can perform binding on the sheets P that are subjected to a print job and are ejected from the image forming apparatus 100.

The crimp binding device 42 and the stapler 43 are provided for the post-processing apparatus 30, and are an example of a sheet processing device that performs given processing, i.e., binding, on the sheet bundle PT including a plurality of sheets P stacked on the internal tray 37. The internal tray 37 is an example of a temporary stacker on which the multiple sheets P are stacked on a temporary basis. The conveyance roller pair 36 is an example of an ejection device that ejects the sheet bundle PT. Before the sheet bundle PT is ejected, the sheet bundle PT is bound at its end and is stacked on the internal tray 37.

The image-forming operation or printing operation of the image forming apparatus 100 in the image forming system 300 is described below with reference to FIG. 1. In the image forming apparatus 100, pairs of conveyance rollers of the document conveying device 110 feed and convey a document D from a document table and convey the document D in a direction indicated by arrow in FIG. 1. By so doing, the original document D passes over the document reading device 102. At that moment in time, the document reading device 102 optically reads the image data of the document D that passes above the document reading device 102.

The image data optically scanned by the document reading device 102 is converted into electrical signals. The electrical signals are then transmitted to a writing device 103. The writing device 103 emits laser beams onto the photoconductor drums 105Y, 105M, 105C, and 105K that correspond to yellow (Y), magenta (M), cyan (C), and black (K), respectively, based on the electrical signals of the image data, and perform the processes of exposure.

In the image forming apparatus 100, a charging process, the exposing process, and a developing process are sequentially executed on the photoconductor drums 105Y, 105M, 105C, and 105K of respective image forming units 104Y, 104M, 104C, and 104K to form desired images on the photoconductor drums 105Y, 105M, 105C, and 105K, respectively.

The images formed on the photoconductor drums 105Y, 105M, 105C, and 105K are transferred and superimposed onto the intermediate transfer belt 178 to form a color image. The color image formed on the intermediate transfer belt 178 is transferred onto the surface of the sheet P fed and conveyed by a sheet feeding roller 197 from the feed tray 112 (second sheet feeder) at a position at which the intermediate transfer belt 178 faces a secondary transfer roller 189.

After the color image is transferred onto the surface of the sheet P, the sheet P is conveyed to the position of the fixing device 120. The fixing device 120 fixes to the sheet P the transferred color image formed on the surface of the sheet P.

Subsequently, based on the selection on the printing mode made by a user, the sheet P is ejected from the image forming apparatus 100 by a first output roller pair 131 to be conveyed to the post-processing apparatus 30 or is ejected from the image forming apparatus 100 by a second output roller pair 132 to be stacked on an output tray 135. When duplex printing is to be performed, the sheet P is ejected from the image forming apparatus 100 to the output tray 135 by the second output roller pair 132, and then the second output roller pair 132 rotates in the reverse direction and switchback conveyance to a reversing path 136 is performed. The reversed sheet P is conveyed to the gap between the secondary transfer roller 189 and the intermediate transfer belt 178, and an image is formed on the rear side.

In the following description, it is assumed in the present embodiment that the post-processing apparatus 30 is coupled to and installed in the in-body space W of the image forming apparatus 100 and selection is made by a user in advance. The image forming apparatus 100 in the image forming system 300 conveys the ejected sheet P to the post-processing apparatus 30, and the post-processing apparatus 30 performs a post-processing on the sheet P conveyed from the image forming apparatus 100.

When the “sort mode” is selected, the sheets P are conveyed while being shifted by the conveyance roller pair 36, which is movable in the width direction parallel to the vertical direction in FIG. 1, in the width direction of each sheet P by a predetermined amount, and are sequentially stacked on the second output tray 32.

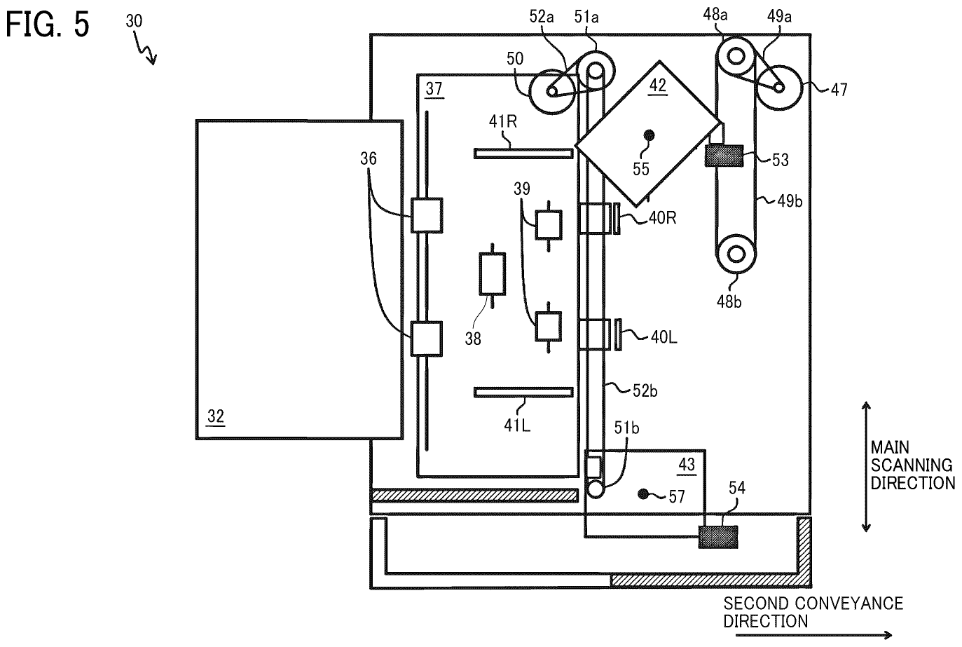

When the “binding mode (stapling mode)” is selected, the sheets P that are conveyed by the conveyance roller pair 33, the conveyance roller pair 34, and the conveyance roller pair 35 are sequentially stacked on the internal tray 37 without being ejected by the conveyance roller pair 36. Under such conditions, every time the sheet P is placed on the internal tray 37, a tapping roller 38 and a return roller 39 that are located above the internal tray 37 move from the standby position to a position where those rollers contact the uppermost sheet P of the sheet bundle PT, and the tapping roller 38 and the return roller 39 are driven and rotated in the counterclockwise direction in FIG. 1. Due to such operations, the uppermost one of the sheets P placed on the internal tray 37 is conveyed and moved toward the end fence 40L and the end fence 40R (see FIG. 5), and the rear end of the multiple sheets P of the sheet bundle PT in the conveyance direction contacts the end fence 40L and the end fence 40R. As a result, the positions of the multiple sheets P in the conveyance direction, which are placed on the internal tray 37, are aligned.

Every time the sheet P is placed on the internal tray 37 or after a desired number of sheets P are stacked on the internal tray 37, a pair of side fences 41L and 41R (see FIG. 5) that serve as jogger fences and are located at both ends of the internal tray 37 in the width direction move in the width direction so as to sandwich the sheet P or sheet bundle PT. Due to such operations, the positions of the sheet bundle PT in the width direction, which is stacked on the internal tray 37, are aligned. Then, the crimp binding device 42 and the stapler 43 performs binding on the rear end of the sheet bundle PT aligned in the sheet conveyance direction and the width direction.

Subsequently, the sheet bundle PT that has been bound is moved obliquely upward along the surface of the internal tray 37 by the rotation in the reverse direction, i.e., the rotation in a clockwise direction as illustrated in FIG. 1, of the return roller 39, and is ejected onto the second output tray 32 by the conveyance roller pair 36.

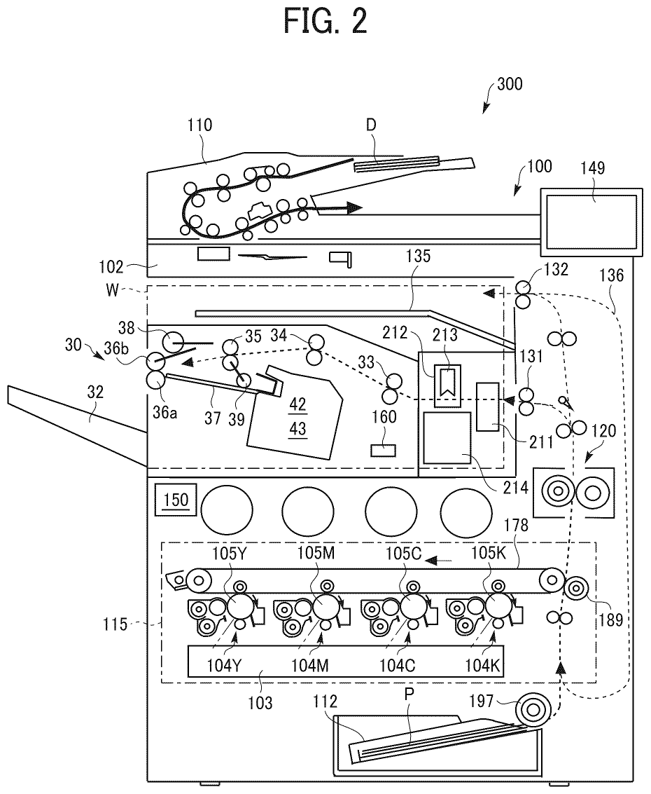

The image forming system 300 according to the second embodiment is described below with reference to FIG. 2. As illustrated in FIG. 2, also in the image forming system 300, a post-processing apparatus 30 with a binding function is installed in the in-body space W of an image forming apparatus 100 in a detachable manner. The first embodiment is different from the second embodiment in a point that, in the given processing to be performed by the post-processing apparatus 30 on the sheets P ejected from the image forming apparatus 100, “punch mode” is selectable in addition to the “sort mode” and the “binding mode (stapling mode)” based on the selection made by a user.

The “sort mode” and the “binding mode (stapling mode)” in the image forming system 300 according to the second embodiment are equivalent to those in the first embodiment, and thus their detailed description is omitted.

When the “punch mode” is selected in the image forming system 300, the positions of the sheets P that have been conveyed by the first output roller pair 131 in the width direction are detected by a horizontal registration sensor 211 by detecting the end faces of the conveyed sheets P. Based on the detection result indicating the positions of the end faces of the sheets P, a hole punch 212 is moved in the width direction. The conveyance of the sheets P is stopped at a point where punching is to be performed, and punch holes are formed by punching pins 213 provided for the hole punch 212. The punch chads in the punching operation fall into a punch chads hopper 214 to be stored. The sheet P is conveyed again after punch holes are formed thereon, and is conveyed to the first output roller pair 131.

The sheets P that has gone through punching processes may further be subjected to the “sort mode” and the “binding mode (stapling mode).”

In the following description, the image forming system 300 that employs an electrophotographic method as illustrated in FIG. 1 and FIG. 2 is described. The image forming apparatus 100 that employs an inkjet printing system may be used.

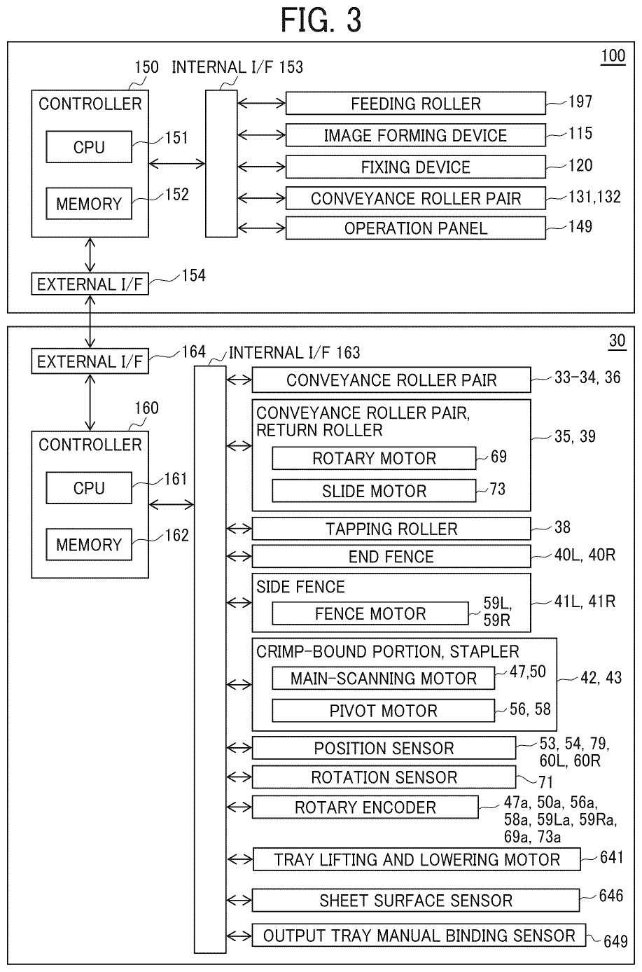

FIG. 3 is a block diagram illustrating a hardware configuration of the image forming system 300.

As illustrated in FIG. 3, the image forming system 300 includes, for example, an image-formation controller 150 that controls the operation of the image forming apparatus 100 and a post-processing controller 160 that controls the operation of the post-processing apparatus 30. The image-formation controller 150 and the post-processing controller 160 cooperate to control the operation of the image forming system 300.

The image-formation controller 150 includes, for example, a central processing unit (CPU) 151 and a memory 152, and the post-processing controller 160 includes, for example, a CPU 161 and a memory 162. Each of the memory 152 and the memory 162 includes, for example, a read-only memory (ROM), a random-access memory (RAM), a hard disk drive (HDD), or a combination of those elements. The image-formation controller 150 causes the CPU 151 to read and execute the program code stored in the memory 152 to achieve the processing described later. The post-processing controller 160 also causes the CPU 161 to read and execute the program code stored in the memory 162 to achieve the processing described later. The program codes that are stored in the memory 152 and the memory 162 or the program codes that are stored in the memory 162 are an example of a program. Such a program will be described later in detail.

The configurations of the image-formation controller 150 and the post-processing controller 160 are not limited to the above-described configurations, and may be implemented with hardware such as application-specific integrated circuits (ASICs) or field-programmable gate arrays (FPGAs).

The image-formation controller 150 controls the operation of the elements of the image forming apparatus 100 such as the feeding roller 197, the image forming device 115, the fixing device 120, the first output roller pair 131, the second output roller pair 132, and the operation panel 149, through an internal interface 153.

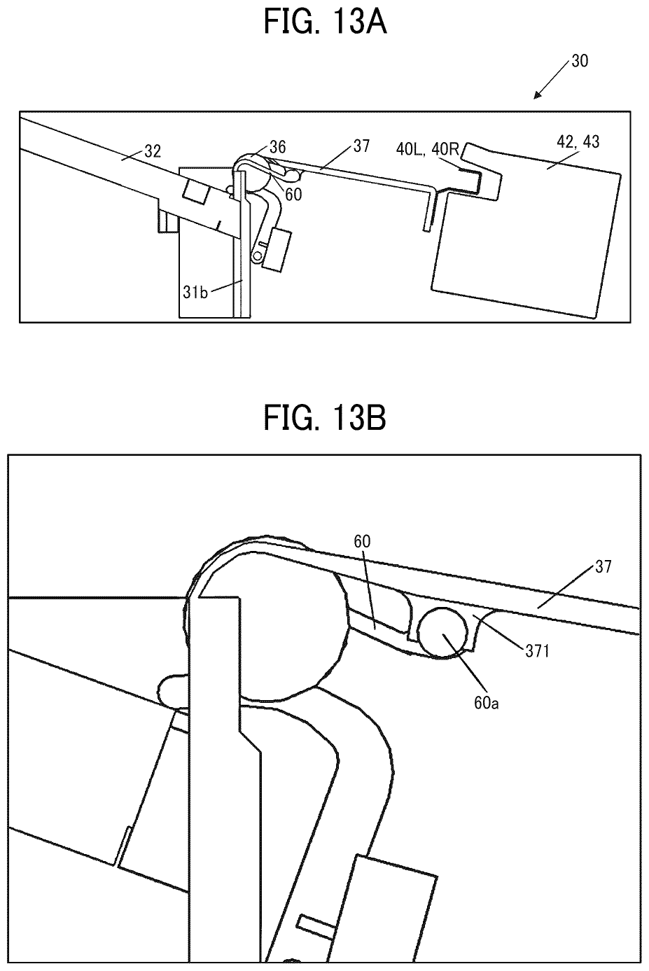

The post-processing controller 160 controls, through an internal interface 163, the operation of the elements of the post-processing apparatus 30 such as the conveyance roller pair 33, the conveyance roller pair 34, the conveyance roller pair 35, the conveyance roller pair 36, a tapping roller 38, the return roller 39, the end fences 40L and 40R, the side fences 41L and 41R, the crimp binding device 42, the stapler 43, position sensors 53, 54, 60L, 60R, and 79, the rotation sensor 71, the rotary encoders 47a, 50a, 56a, 58a, 59La, 59Ra, 69a, and 73a, a tray lifting and lowering motor 641, a sheet surface sensor 646, and the output tray manual binding sensor 649. In FIG. 13A and FIG. 13B, a few motors and sensors are illustrated, but each component is driven by a motor that is an example of a driving source, and the state of operation such as the position or orientation is detected by a sensor.

The operation panel 149 includes an input unit to accept the input made by a user and a display or notification unit to notify a user of information. The input unit includes, for example, hard keys and a touch screen overlaid on the display. The operation panel 149 acquires information from the operator through an input unit and provides the operator with information through the display. A specific example of the notifier is not limited to the display and may be a light-emitting diode (LED) lamp or a loudspeaker.

The rotary encoders 47a, 50a, 56a, 58a, 59La, 59Ra, 69a, and 73a detect the amount of movement or revolutions per minute (rpm) of a main-scanning motors 47 and 50, pivot motors 56 and 58, fence motors 59L and 59R, a rotary motor 69, and a slide motor 73, respectively. More specifically, the rotary encoders 47a, 50a, 56a, 58a, 59La, 59Ra, 69a, and 73a output pulse signals to the post-post-processing controller 160 as the main-scanning motors 47 and 50, the pivot motors 56 and 58, the fence motors 59L and 59R, the rotary motor 69, and the slide motor 73 rotate. The post-processing controller 160 counts the number of the pulse signals output from the rotary encoders 47a, 50a, 56a, 58a, 59La, 59Ra, 69a, and 73a to know the amount of movement of the main-scanning motors 47 and 50, the pivot motors 56 and 58, the fence motors 59L and 59R, the rotary motor 69, and the slide motor 73, respectively.

The post-processing controller 160 monitors the current position of the crimp binding device 42 in the main scanning direction based on the detection results of the position sensor 53 in combination with the detection results of the rotary encoder 47a. In other words, the position sensor 53 and the rotary encoder 47a are combined to detect the position of the crimp binding device 42 in the main scanning direction. In a similar manner, the post-processing controller 160 monitors the current position of the stapler 43 in the main scanning direction based on the detection results of the position sensor 54 in combination with the detection results of the rotary encoder 50a. In other words, the position sensor 54 and the rotary encoder 50a are combined to detect the position of the stapler 43 in the main scanning direction.

The post-processing controller 160 monitors the current positions of the side fences 41L and 41R in the main scanning direction based on the detection results of the position sensors 60L and 60R in combination with the detection results of the rotary encoders 59La and 59Ra. In other words, the position sensors 60L and 60R and the rotary encoders 59La and 59Ra are combined to detect the position of the side fences 41L and 41R in the main scanning direction.

The post-processing controller 160 monitors the revolutions per minute (rpm) of the conveyance roller pair 35 in the circumferential direction based on the detection results of the rotation sensor 71 in combination with the detection results of the rotary encoder 69a. In other words, the rotation sensor 71 and the rotary encoder 69a may be combined to detect the revolutions per minute (rpm) of the conveyance roller pair 35 in the circumferential direction.

The post-processing controller 160 monitors the current position of the conveyance roller pair 35 in the main scanning direction based on the detection results of the position sensor 79 in combination with the detection results of the rotary encoder 73a. In other words, the position sensor 79 and the rotary encoder 73a are combined to detect the position of the conveyance roller pair 35 in the main scanning direction.

The post-processing controller 160 drives the tray lifting and lowering motor 641 to rotate based on the detection results of the sheet surface sensor 646 and the output tray manual binding sensor 649, and controls the lifting and lowering movement of the second output tray 32. The post-processing controller 160 changes the positions of the guide 60 and the slide guide 602 as will be described later in detail, based on a combination of the detection results of the sheet surface sensor 646 and the output tray manual binding sensor 649.

The image-formation controller 150 and the post-processing controller 160 are coupled to each other through an external interface 154 and an external interface 164 to communicate with each other. The image-formation controller 150 and the post-processing controller 160 cooperate to control the operation of the multiple elements based on the information transmitted and received through the external interface 154 and the external interface 164.

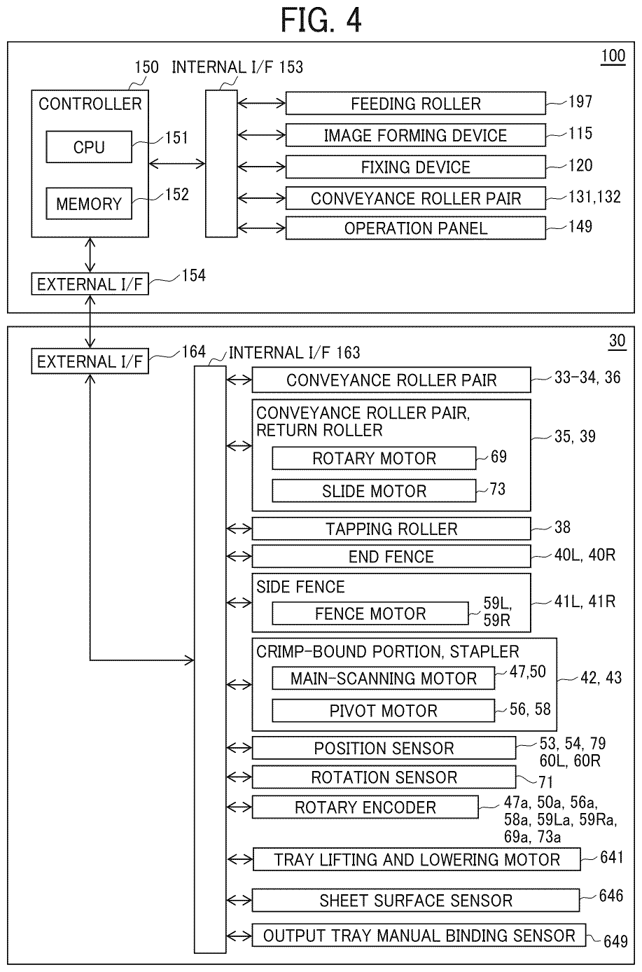

FIG. 4 is another block diagram illustrating a hardware configuration of the image forming system 300. FIG. 4 is different from FIG. 3 in that the post-processing controller 160 of the post-processing apparatus 30 is omitted, and is the same as FIG. 13A and FIG. 13B in the other points. The image-formation controller 150 illustrated in FIG. 4 controls the operations of the components of the image forming apparatus 100 through the internal interface 153, and controls the operations of the components of the post-processing apparatus 30 through the external interface 154, the external interface 164, and the internal interface 163. In other words, the post-processing apparatus 30 as illustrated in FIG. 4 operates under the control of the image-formation controller 150 provided for the image forming apparatus 100.

FIG. 5 is a plan view of the post-processing apparatus 30, illustrating its inner structure according to the first embodiment.

The post-processing apparatus 30 performs binding (post-processing) that binds multiple sheets P (sheet bundle PT) on which images are formed by the image forming device 115. As illustrated in FIG. 2 and FIG. 3, the post-processing apparatus 30 is provided with a casing 31, the second output tray 32, the multiple conveyance roller pairs 33, 34, 35, and 36 each of which is an example of a mover, the internal tray 37 that is an example of a sheet loading unit, the tapping roller 38, the return roller 39 that is an example of a second mover, the end fences 40L and 40R that are an example of an adjuster in the conveyance direction, the side fences 41L and 41R that are an example of an adjuster in the main scanning direction, the crimp binding device 42, and a stapler 43.

In the following description, a direction in which the sheet P proceeds to the second output tray 32 along the conveyance path Ph1 may be referred to as the first conveyance direction, and a direction in which the sheet P proceeds to the end fence 40L and the end fence 40R along the top face of the internal tray 37 may be referred to as the second conveyance direction. In other words, the first conveyance direction and the second conveyance direction are at different angles. More specifically, the first conveyance direction and the second conveyance direction are different from each other on a same plane orthogonal to the width direction of the sheet P. A direction orthogonal to the first conveyance direction, the second conveyance direction, and the thickness direction of the sheet S supported on the internal tray 37, which is parallel to the width direction of the sheet P, is referred to as the “main scanning direction.”

The casing 31 has a box shape to form an internal space for accommodating components of the post-processing apparatus 30. The conveyance path Ph1 as a space through which the sheet P passes is formed in the internal space of the casing 31. The second output tray 32 is supported on the outer side face of the casing 31. On the second output tray 32, the sheet P or the sheet bundle PT that is conveyed by the conveyance roller pair 33, the conveyance roller pair 34, the conveyance roller pair 35, and the conveyance roller pair 36 is stacked.

The conveyance roller pair 33, the conveyance roller pair 34, the conveyance roller pair 35, and the conveyance roller pair 36 are arranged on the conveyance path Ph1 at given intervals. The conveyance roller pair 33, the conveyance roller pair 34, the conveyance roller pair 35, and the conveyance roller pair 36 convey the sheet P along the conveyance path Ph1. The conveyance roller pair 33 includes a drive roller 33a and a driven roller 33b that face each other across the conveyance path Ph1. The drive roller 33a and the driven roller 33b are rotatably supported by the casing 31. When the driving force for rotation is transmitted from a conveyance motor to the drive roller 33a, the drive roller 33a rotates forward in the direction of conveying the sheet P (e.g., a counterclockwise (CCW) direction in FIG. 2). The driven roller 33b is disposed facing the drive roller 33a across the conveyance path Ph1 and is driven by the rotation of the drive roller 33a. As the conveyance motor is driven with the drive roller 33a and the driven roller 33b nipping the sheet P, the sheet P is conveyed along the conveyance path Ph1.

A basic configuration of the conveyance roller pairs 34 to 36 is common to the configuration of the conveyance roller pair 33. The conveyance roller pair 36, which is an example of a conveyance roller, includes a drive ejection roller 36a that makes up a sheet ejection unit and a driven ejection roller 36b that can be brought into contact with and separated from the drive ejection roller 36a. The conveyance roller pair 35, which is an example of the first mover, is slidable in the width direction in order to implement a sorting function to shift the sheet P in the width direction and ejecting the sheet P to the second output tray 32. Such a roller pair may be referred to as a shift roller.

The internal tray 37 temporarily supports and accumulates multiple sheets P that are conveyed by the conveyance roller pair 36. The tapping roller 38 is supported at one end of a rotary arm above the internal tray 37. As the rotary arm rotates, the tapping roller 38 feeds the sheet P to the internal tray 37. The return roller 39 contacts the upper side of the sheet S supported on the internal tray 37 and rotates to guide the sheet P toward the conveyance roller pair 36.

The end fences 40L and 40R contact a downstream end of the sheets P supported on the internal tray 37 in the first conveyance direction and align the positions of the sheets P in the conveyance direction. The side fences 41L and 41R contact both ends of the sheet S supported on the internal tray 37 in the width direction to align the position of the sheets P in the main scanning direction. More specifically, the driving force of the fence motors 59L and 59R (see FIG. 3) is conveyed to the side fences 41L and 41R, and the side fences 41L and 41R can move independently of each other in the main scanning direction.

The post-processing apparatus 30 includes position sensors 60L and 60R (see FIG. 3). The position sensors 60L and 60R detect that the side fences 41L and 41R are located at standby positions in the main scanning direction. For example, the standby positions are positions where the distance in the main scanning direction is longest. In other words, the standby positions are positions wider than the maximum width of the sheet P, which can be accumulated in the internal tray 37, in the main scanning direction. For example, the position sensors 60L and 60R output position signals to the post-processing controller 160 when the side fences 41L and 41R are located at standby positions, and stop outputting position signals when the side fences 41L and 41R are located at positions different from the standby positions. The configuration of the position sensors 60L and 60R is not limited to any particular configuration, and for example, mechanical sensors, optical sensors, or magnetic sensors can be employed. The same applies to the other sensors.

The crimp binding device 42 and the stapler 43, which are an example of a binding device, are disposed at positions at the downstream end of the sheet bundle PT, which is supported on the internal tray 37, in the second conveyance direction. The crimp binding device 42 and the stapler 43 move independently in the main scanning direction along the sheet bundle PT supported on the internal tray 37. Moreover, the crimp binding device 42 and the stapler 43 pivot independently around a rotary shaft 55 and a rotary shaft 57, respectively, each of which extends in the thickness direction of the sheet P supported on the internal tray 37. For example, the crimp binding device 42 presses and deforms a sheet bundle PT to bind the sheet bundle PT. For example, the stapler 43 makes the staple N penetrate the sheet bundle Sb to bind the sheet bundle PT. The post-processing apparatus 30 may include only one of the crimp binding device 42 and the stapler 43 or may include both of the crimp binding device 42 and the stapler 43.

The crimp binding device 42 moves in the main scanning direction by a main-scanning motor 47, a driving pulley 48a, a driven pulley 48b, an annular seamless belt 49a, and an annular seamless belt 49b. The main-scanning motor 47 generates a driving force for moving the crimp binding device 42 in the main scanning direction. The driving pulley 48a and the driven pulley 48b are rotatably supported by the casing 31 at positions away from each other in the main scanning direction. The annular seamless belt 49a is looped around the output shaft of the main-scanning motor 47 and the driving pulley 48a. The annular seamless belt 49b is looped around the driving pulley 48a and the driven pulley 48b. The crimp binding device 42 is attached to the annular seamless belt 49b.

The driving force of the main-scanning motor 47 is transmitted to the driving pulley 48a through the annular seamless belt 49a. The annular seamless belt 49b circulates around the driving pulley 48a and the driven pulley 48b in accordance with rotation of the driving pulley 48a. As a result, the crimp binding device 42 that is attached to the annular seamless belt 49b moves in the main scanning direction. The driving pulley 48a, the driven pulley 48b, and the annular seamless belt 49a, and the annular seamless belt 49b are an example of a driving-force transmission mechanism that transmits the driving force of the main-scanning motor 47 to the crimp binding device 42. However, the specific configuration of the driving-force transmission mechanism is not limited to the above-described example.

The stapler 43 moves in the main scanning direction by a main-scanning motor 50, a driving pulley 51a, a driven pulley 51b, and an annular seamless belt 52a, and an annular seamless belt 52b. The main-scanning motor 50 generates a driving force for moving the stapler 43 in the main scanning direction. The driving pulley 51a and the driven pulley 51b are rotatably supported by the casing 31 at positions away from each other in the main scanning direction. The annular seamless belt 52a is looped around the output shaft of the main-scanning motor 50 and the driving pulley 51a. The annular seamless belt 52b is looped around the driving pulley 51a and the driven pulley 51b. The stapler 43 is attached to the annular seamless belt 52b.

The driving force of the main-scanning motor 50 is transmitted to the driving pulley 51a through the annular seamless belt 52a. The annular seamless belt 52b circulates around the driving pulley 51a and the driven pulley 51b in accordance with rotation of the driving pulley 51a. Accordingly, the stapler 43 attached to the annular seamless belt 52b moves in the main scanning direction. The driving pulley 51a, the driven pulley 51b, and the annular seamless belt 52a, and the annular seamless belt 52b are an example of a driving-force transmission mechanism that transmits the driving force of the main-scanning motor 50 to the stapler 43. However, the specific configuration of the driving-force transmission mechanism is not limited to the above-described example.

The post-processing apparatus 30 includes the position sensor 53 and the position sensor 54. The position sensor 53 and the position sensor 54 detect the positions of the crimp binding device 42 and the crimp binding device 43, respectively, in the main scanning direction. The position sensor 53 outputs a position signal to the post-processing controller 160, for example, when the crimp binding device 42 that is an example of a sheet processing device is disposed at a predetermined position (home positions) in the main scanning direction, and stop outputting the position signal when the crimp binding device 42 is disposed at a position different from the home position. The position sensor 54 outputs a position signal to the post-processing controller 160, for example, when the stapler 43 that is an example of a sheet processing device is disposed at a predetermined position (home position) in the main scanning direction, and stops outputting the position signal when the stapler 43 is disposed at a position different from the home position.

The crimp binding device 42 is supported on the casing 31 so as to be pivotable around the rotary shaft 55 extending in the thickness direction of the sheet P supported on the internal tray 37. The crimp binding device 42 is driven by the driving force transmitted from the pivot motor 56 (see FIG. 3) to pivot between a parallel binding posture and an oblique binding posture. In a similar manner, the stapler 43 is driven by the driving force transmitted from the pivot motor 58 to pivot around the rotary shaft 57 extending in the thickness direction of the sheet P supported on the internal tray 37.

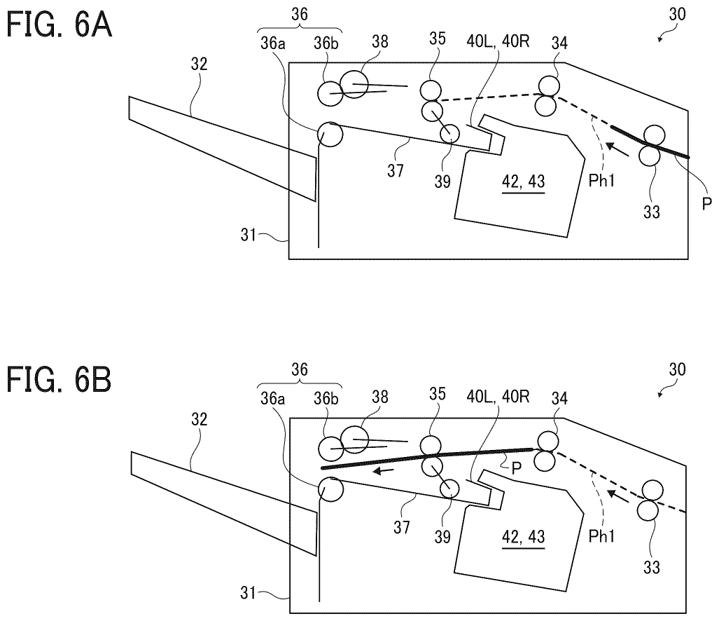

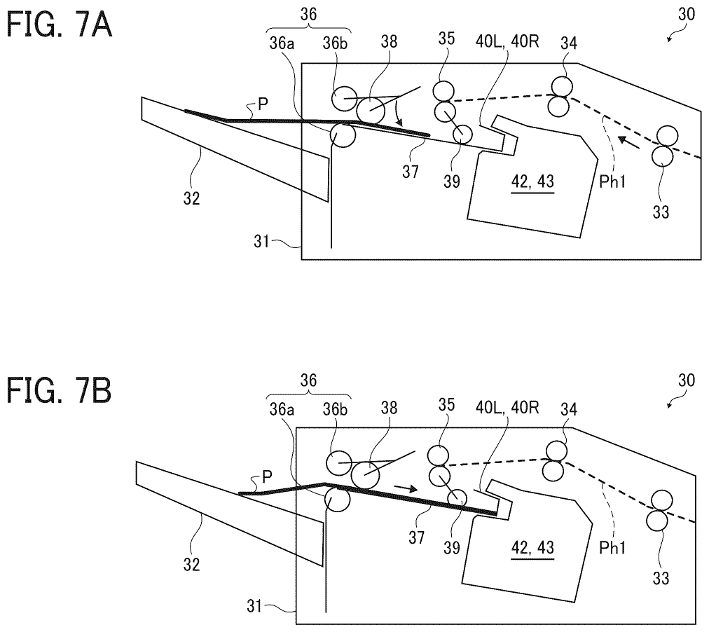

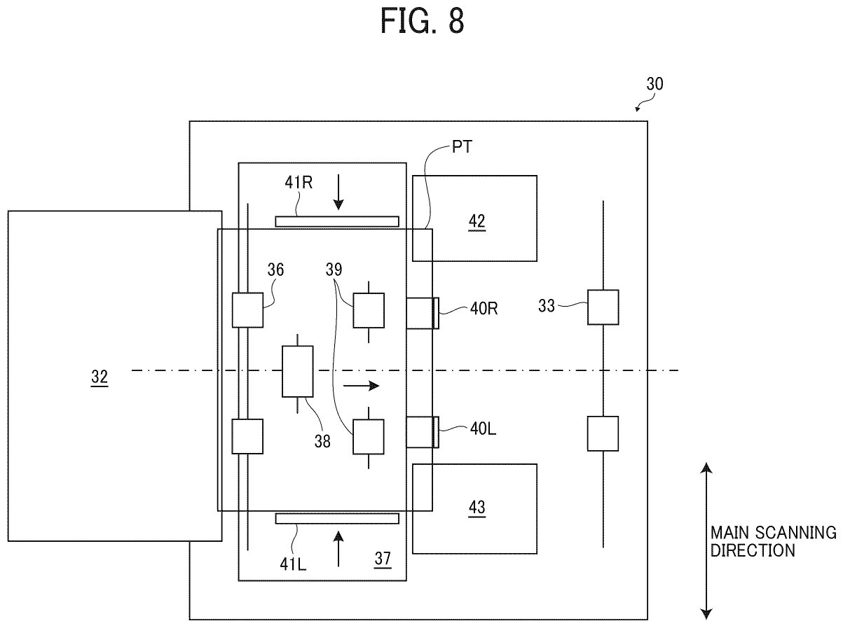

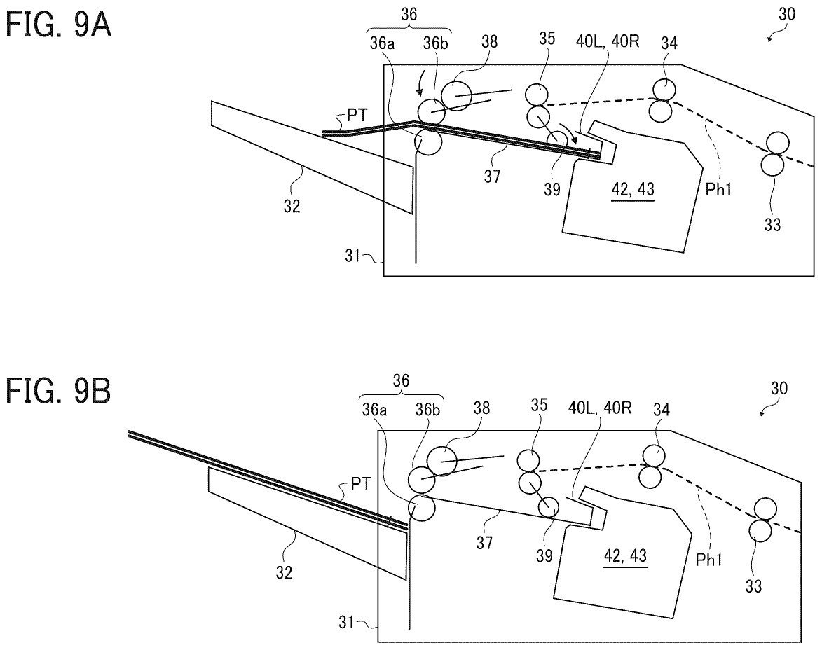

How binding is performed is described below with reference to FIG. 6A, FIG. 6B, FIG. 7A, FIG. 7B, FIG. 8, FIG. 9A, and FIG. 9B.

FIG. 6A and FIG. 6B are diagrams illustrating the post-processing apparatus 30 and how the sheet P passes through or reaches the conveyance roller pair 36.

FIG. 7A and FIG. 7B are diagrams illustrating how the post-processing apparatus 30 performs binding.

FIG. 8 is a diagram illustrating the post-processing apparatus 30 of FIG. 7B as viewed in the thickness direction of the sheet P.

FIG. 9A and FIG. 9B are diagrams illustrating the post-post-processing apparatus 30 that ejects the sheet bundle PT having been bound to the second output tray 32.

As illustrated in FIG. 6A and FIG. 6B, the post-processing apparatus 30 rotates the conveyance roller pair 33, the conveyance roller pair 34, and the conveyance roller pair 35 in the forward direction to conveys the sheet P supplied from the image forming device 115 along the conveyance path Ph1. Under such conditions, in the conveyance roller pair 36, the drive ejection roller 36a and the driven ejection roller 36b are separated from each other. The conveyance roller pair 36 includes a pair of rotors that are typically rollers. In other words, the conveyance roller pair 36 includes a drive ejection roller 36a that makes up a sheet ejection unit and is an example of an ejection device and a driven ejection roller 36b that can be brought into contact with and separated from the drive ejection roller 36a. The drive ejection roller 36a, which is one rotator, is located at a relatively lower position, and is an example of a lower rotator. The driven ejection roller 36b, which is the other rotator, is located at a relatively upper position, and is an example of an upper rotator.

As illustrated in FIG. 7A, the post-processing apparatus 30 lets the sheet P that has passed through the conveyance roller pair 35 drop on the internal tray 37. As illustrated in FIG. 7B, the post-processing apparatus 30 causes the tapping roller 38 to contact the sheet P on the internal tray 37 and rotate and store the sheet S in the internal tray 37.

Subsequently, as illustrated in FIG. 8, the sheet P is conveyed by the tapping roller 38 until downstream ends of the sheets P in the second conveyance direction, which are accumulated on the internal tray 37, contact the end fence 40L and the end fence 40R, and ends of the sheets P in the conveyance direction are aligned by the end fence 40L and the end fence 40R. Further, the post-processing apparatus 30 moves the side fences 41L and 41R in the main scanning direction to align the positions of the sheets P stored in the internal tray 37 in the main scanning direction, and such an operation may be referred to as jogging. The post-processing apparatus 30 repeats the operations illustrated in FIG. 6A, FIG. 6B, FIG. 7A, FIG. 7B, and FIG. 8 so as to form the sheet bundle PT on the internal tray 37.

As illustrated in FIG. 9A, the post-processing apparatus 30 causes the crimp binding device 42 or the stapler 43 to face the binding position of the sheet bundle PT in response to a given number of sheets P being stacked on the internal tray 37. The post-processing apparatus 30 drives the crimp binding device 42 or the stapler 43 to bind the sheet bundle PT supported on the internal tray 37. Further, as illustrated in FIG. 9B, the post-processing apparatus 30 rotates the conveyance motor in the reverse direction to make the conveyance roller pair 36 to eject the sheet bundle PT to the second output tray 32 that is an example of a sheet-bundle stacker.

The processes of the manual binding that are executable by the post-processing apparatus 30 are described below.

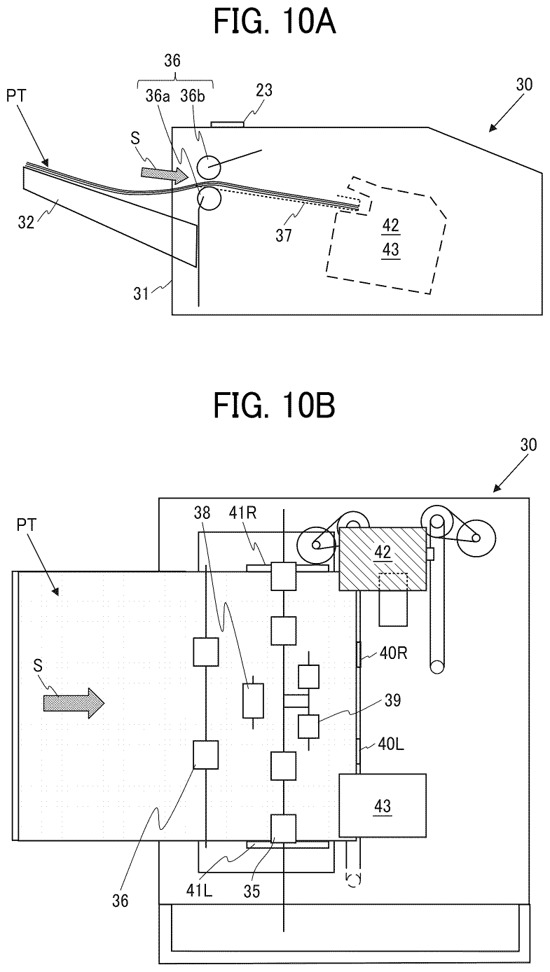

FIG. 10A is a side view of the post-processing apparatus 30, illustrating how the sheet bundle PT is manually fed through an ejection port provided with the conveyance roller pair 36 that is an example of the ejection device of the post-processing apparatus 30.

FIG. 10B is a top view of the post-processing apparatus 30, illustrating how the sheet bundle PT is manually fed through the ejection port.

The sheet bundle PT with any desired number of sheets can manually be inserted through an ejection port of the post-processing apparatus 30 in the direction indicated by an arrow S and be set on the internal tray 37. When the sheet bundle PT is manually fed, the driven ejection roller 36b that makes up the conveyance roller pair 36 is at a lifted position. Under such conditions, the sheet bundle PT is inserted into the gap between the driven ejection roller 36b and the drive ejection roller 36a, which is an example of the ejection port.

After the sheet bundle PT is inserted through the ejection port and is placed on the sheet table of the internal tray 37, a user releases his or her hand from the sheet bundle PT, and operates, touches, or presses down a manual binding mode key 23, or touches or presses down the manual binding start screen displayed on the operation panel 149 (see FIG. 1 or FIG. 2). With those operations, the sheet bundle PT is automatically bound by the crimp binding device 42 or the stapler 43.

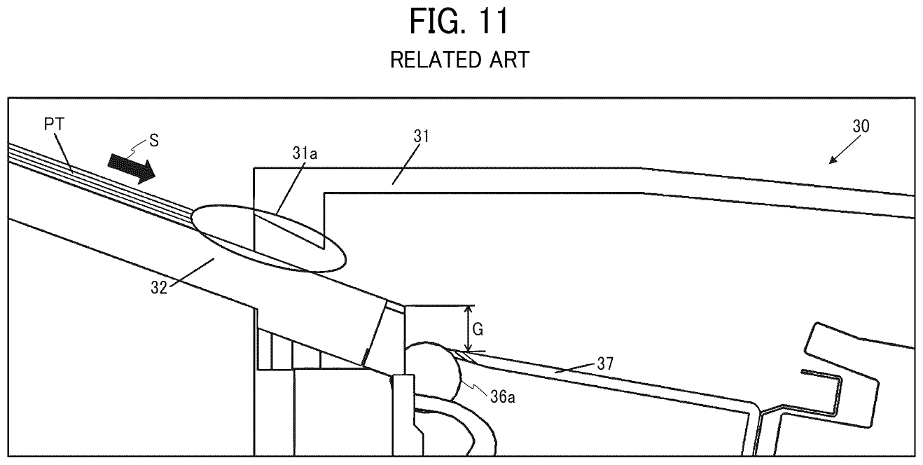

A comparative example is described below with reference to FIG. 11.

In FIG. 11, the second output tray 32 is moved to a lifted position in the post-processing apparatus 30 that is located in the in-body space W of the image forming apparatus 100. In the post-processing apparatus 30 according to a comparative example, an opening 31a that serves as an ejection port for the sheet P or the sheet bundle PT is formed at a position downstream from the conveyance roller pair 36 in the ejection direction. Due to such a configuration, when the position of the drive ejection roller 36a of the conveyance roller pair 36 is too high, the opening 31a between (the inner surface of the above-described opening of) the casing 31 of the post-processing apparatus 30 and the second output tray 32 into which the sheet bundle PT is inserted gets narrow, and it becomes difficult to insert the sheet bundle PT manually.

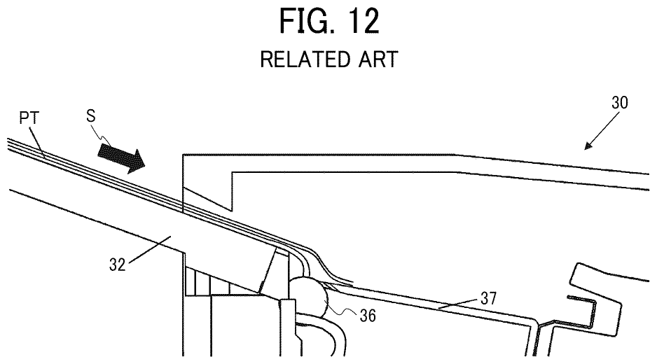

If the sheet bundle PT composed of thin sheets P with low elasticity or resilience such as so-called thin paper is inserted through the opening 31a and the second output tray 32 is at a lifted position as illustrated in FIG. 12, a gap G with the drive ejection roller 36a of the conveyance roller pair 36 in the vertical direction is large (see FIG. 11). Accordingly, the front end of the sheet P in the insertion direction is bent and deformed downward due to the effect of gravity, and moves into the sheet table of the internal tray 37 from the sheet table of the second output tray 32. Such conditions do not only affect the entry but also may damage the sheet bundle PT when the sheet bundle PT deeply moves into the internal tray 37.

Compared with the above-described comparative example, the post-processing apparatus 30 is provided with the guide 60, and the sheet bundle PT to be manually bound can easily be inserted through the opening 31a as described above. Accordingly, the sheet bundle PT can be prevented from being damaged. The post-processing apparatus 30 provided with the guide 60 is described below.

### FIRST EXAMPLE

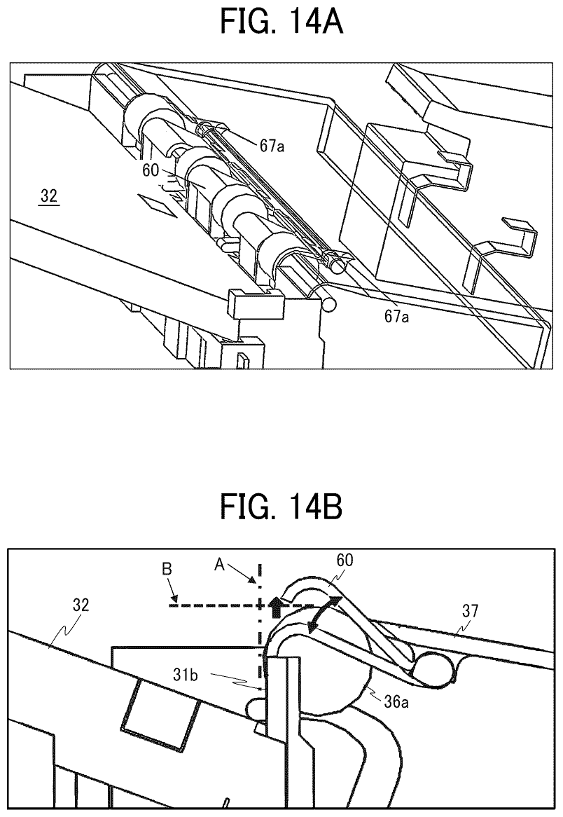

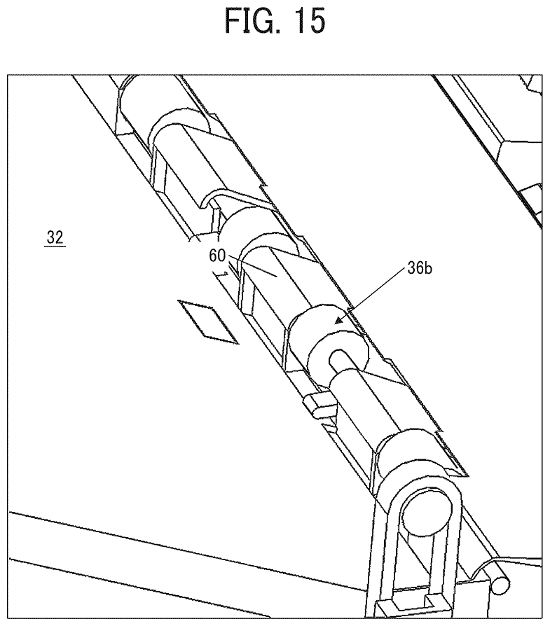

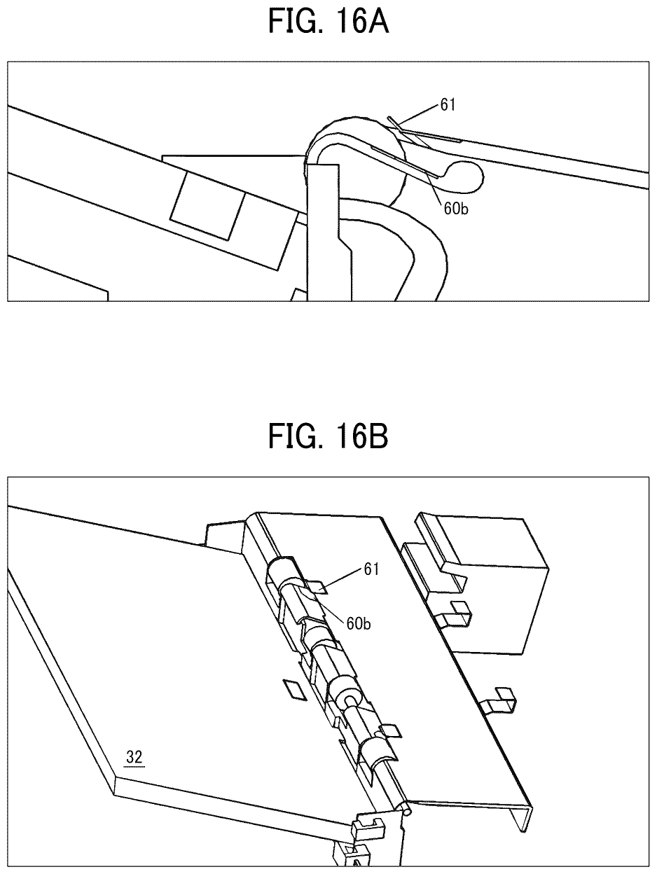

The post-processing apparatus 30 according to the first example is described below with reference to FIG. 13A, FIG. 13B, FIG. 14A, FIG. 14B, FIG. 15, FIG. 16A, and FIG. 16B.

FIG. 13A is a diagram illustrating a configuration of the guide 60 that protects the conveyance roller pair 36 (drive ejection roller 36a).

FIG. 13B is a magnified view of the guide 60 and elements around the guide 60.

As illustrated in FIG. 13B, the guide 60 is held at a predetermined position, and a guide shaft 60a is held at a shaft fitting part 371 of the internal tray 37 in a pivotable manner. The guide 60 covers the outer round surface of the drive ejection rollers 36a so as to prevent the collision or friction between the sheet bundle PT and the drive ejection roller 36a when the sheet bundle PT is inserted through the opening 31a.

FIG. 14A and FIG. 14B are diagrams illustrating a fixed position of the guide 60 provided for the post-processing apparatus 30.

As illustrated in FIG. 14A, the guide 60 prevents the sheet bundle PT from contacting the drive ejection roller 36a when the sheet bundle PT is to be inserted into the internal tray 37 and be stacked thereon. The guide shaft 60a is located at a rear portion of the guide 60 in the thickness direction of the sheet P, and is fixed to the shaft fitting part 67a of the internal tray 37 in a pivotable manner.

FIG. 14B illustrates a guide position and a retracted position for the guide 60.

When the sheet bundle PT is to be inserted into the internal tray 37 and be stacked thereon, the top face of the guide 60 is at a position above the top face of the drive ejection roller 36a as indicated by a broken line B in FIG. 14B. The position that is indicated by the broken line B is the guide position, and may be referred to as the first position in the following description. Except when the sheet bundle PT is to be inserted into the internal tray 37 and be stacked thereon, the top face of the guide 60 is at a position under the top face of the drive ejection roller 36a, and such a position under the top face of the drive ejection roller 36a may be referred to as a retracted position or the second position in the following description. Note that FIG. 14A is a perspective view of the guide 60 at the second position and elements around the guide 60.

Front end of the guide 60 at the second position is held so as to be inner than that extension toward the inside of the post-processing apparatus 30 or on the extension of a side face of the drive ejection roller 36a along the housing wall 31b or a position indicated by a dot-and-dash line A in FIG. 14B. In other words, the front end of the guide 60 at the second position is at a position inner than the housing wall 31b that corresponds to a downstream end in the sheet ejection direction.

The front end of the guide 60 at the second position contacts the top face of the housing wall 31b that contacts the rear end of the sheet P ejected to the second output tray 32, and falls within the diameter of the drive ejection roller 36a. In other words, the front end of the guide 60 at the second position falls within the width of the drive ejection roller 36a in the sheet ejection direction. As described above, the top face of the guide 60 moves to the first position above the top face of the drive ejection roller 36a. Due to such a configuration, the sheet P can be prevented from contacting the drive ejection roller 36a. As the guide 60 moves to the second position, the sheet P can be prevented from interfering with the guide 60 when the drive ejection roller 36a contacts the driven ejection roller 36b and the sheet P is ejected.

The front end of the guide 60 at the second position is at the position of the drive ejection roller 36a along the housing wall 31b or is located more inside the post-processing apparatus 30 than the drive ejection roller 36a. Due to such a configuration, when the table of the second output tray 32 is lifted to a position higher than the drive ejection roller 36a, the front end of the guide 60 is prevented from contacting the sheet stacking table of the second output tray 32 on which the sheet P or the sheet bundle PT is stacked. When the second output tray 32 is moved upward with the sheet P stacked thereon, the front end of the guide 60 is prevented from contacting the top face of the sheet P.

By contrast, when the guide 60 is moved upward, the entry of the sheet bundle PT along the top face of the guide 60 is guided even if the front end of the sheet bundle PT is inclined downward when the sheet bundle PT is inserted. Accordingly, the sheet bundle PT can be manually fed with greater operability.

### SECOND EXAMPLE

The post-processing apparatus 30 according to the second example is described below.

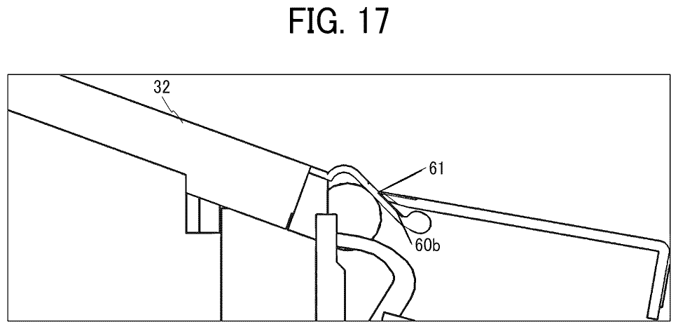

In the second example, as illustrated in FIG. 16A, FIG. 16B, and FIG. 17, a MYLAR 61 composed of a flexible sheet is disposed at a downstream end of the internal tray 37 in the ejection direction of the sheet P. The MYLAR 61 is located so as to contact the sheet P when the sheet P ejected from the image forming apparatus 100 is conveyed to the internal tray 37 through the conveyance roller pair 35 that is an example of a shifting conveyance roller. As illustrated in FIG. 16A, the front end of the MYLAR 61 projects to a position above the top face of the internal tray 37, i.e., the table on which the sheet P is placed. With the provision of the MYLAR 61, the contact resistance of the sheet P with the drive ejection roller 36a can be reduced when switchback conveyance is performed for the sheet P conveyed to the internal tray 37 using the tapping roller 38 and the return roller 39, and the load of conveying the sheet P in switchback conveyance can be reduced.

When the “binding mode (stapling mode)” is selected as the operation setting of the post-processing apparatus 30, the front end of the MYLAR 61 projects to a position above the top face of the internal tray 37, and the guide 60 is at a retracted position similar to that of the first embodiment.

As illustrated in FIG. 17, a guide trench 60b that is a concave portion where the MYLAR 61 enters is formed on the top face of the guide 60. When the guide 60 moves upward, the front end of the MYLAR 61 is accommodated in the guide trench 60b. Accordingly, the front end of the MYLAR 61 does not stick out from the top face of the guide 60 when the guide 60 moves upward.

When the guide 60 is lifted and the sheet bundle PT is inserted through the opening 31a, the front end of the sheet bundle PT can enter while contacting the top face of the guide 60 and the top face of the MYLAR 61 but without contacting the drive ejection roller 36a. Accordingly, the front end of the sheet bundle PT does not get stuck by the front end of the MYLAR 61, and the difficulty in insertion can be prevented.

In the second example, the functionality of the MYLAR 61 for switchback conveyance is maintained, and the MYLAR 61 enters the guide trench 60b when the guide 60 moves upward with the concave portion of the guide 60. Accordingly, a step or level difference can be reduced, and the sheet P can easily be manually fed through the opening 31a.

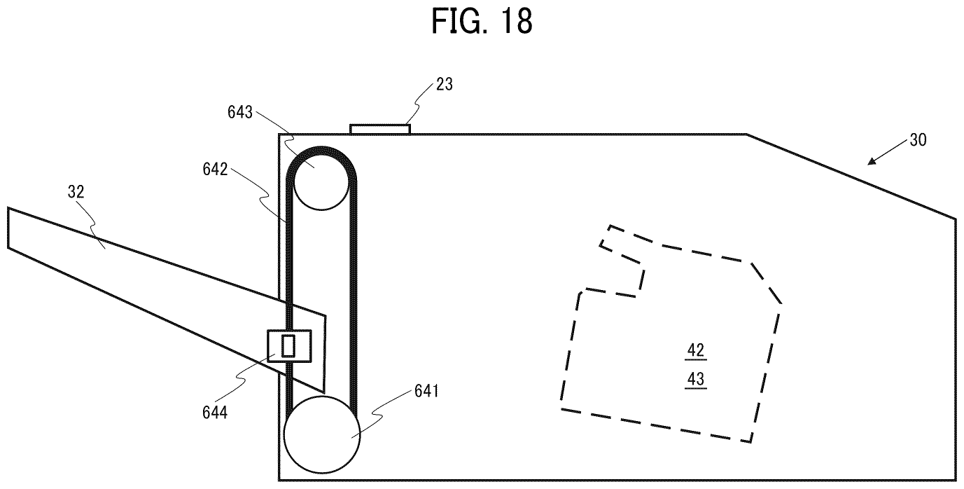

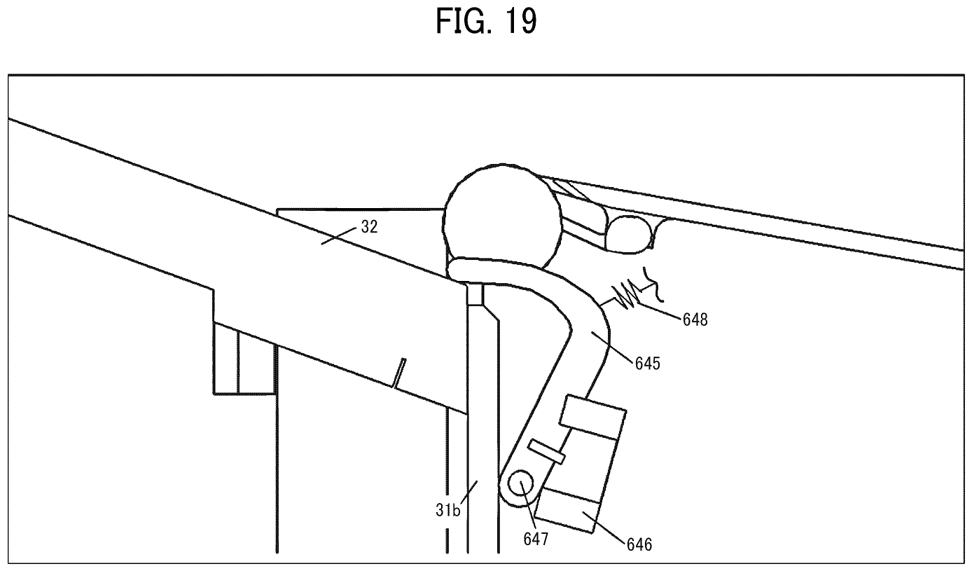

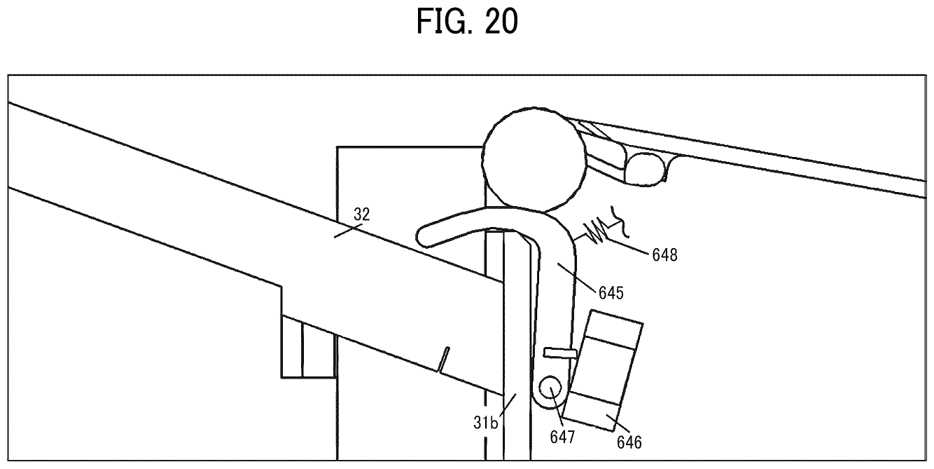

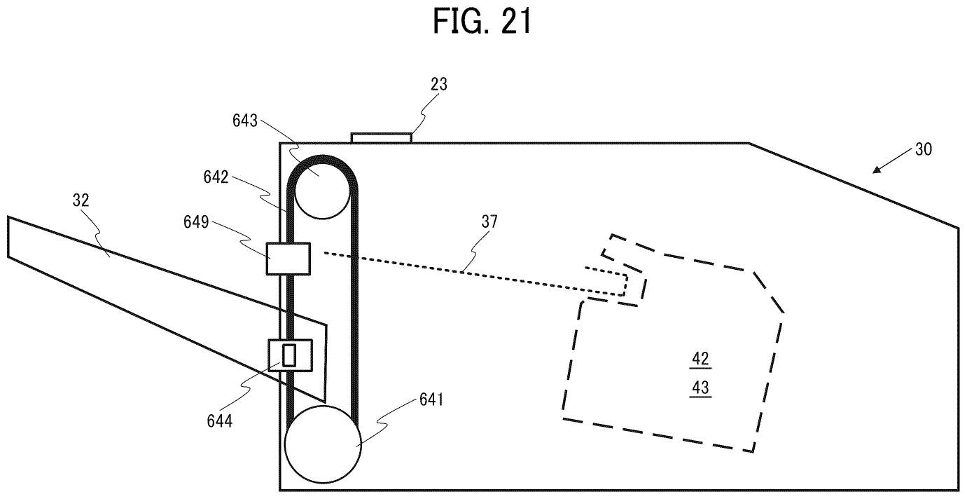

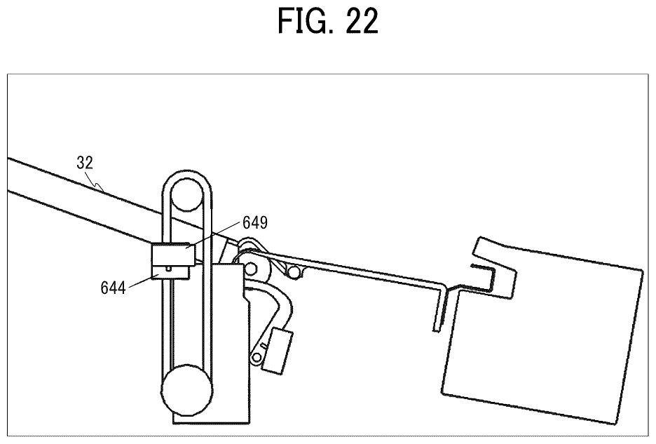

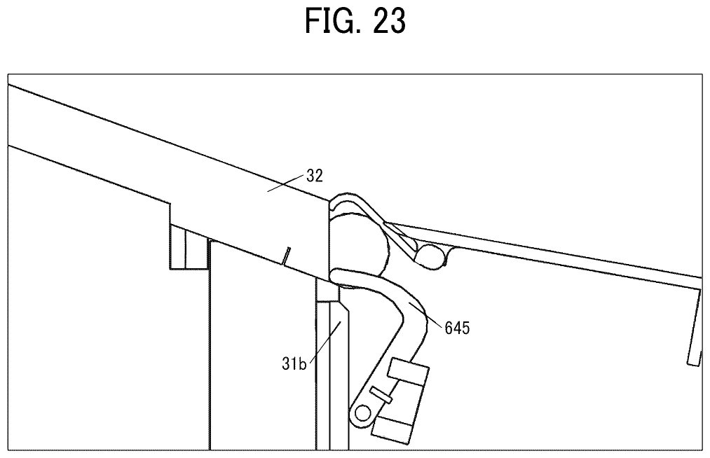

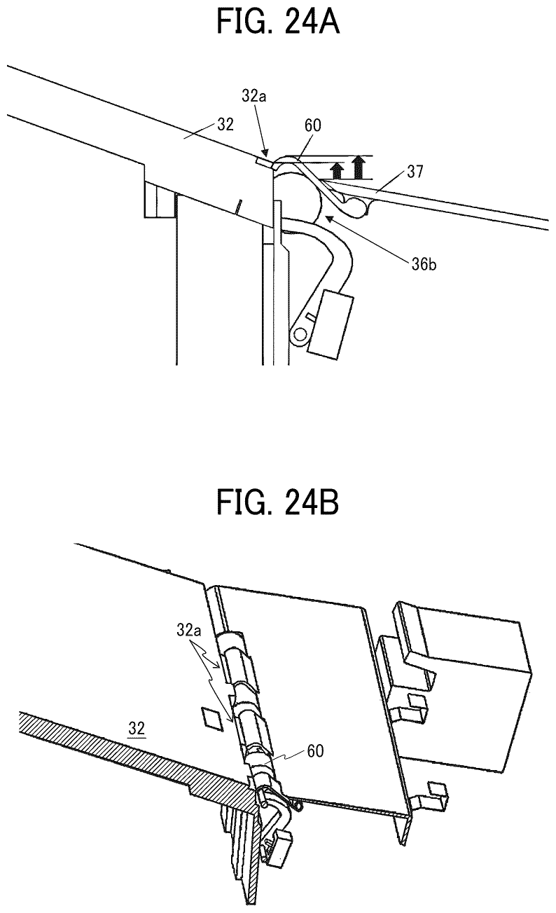

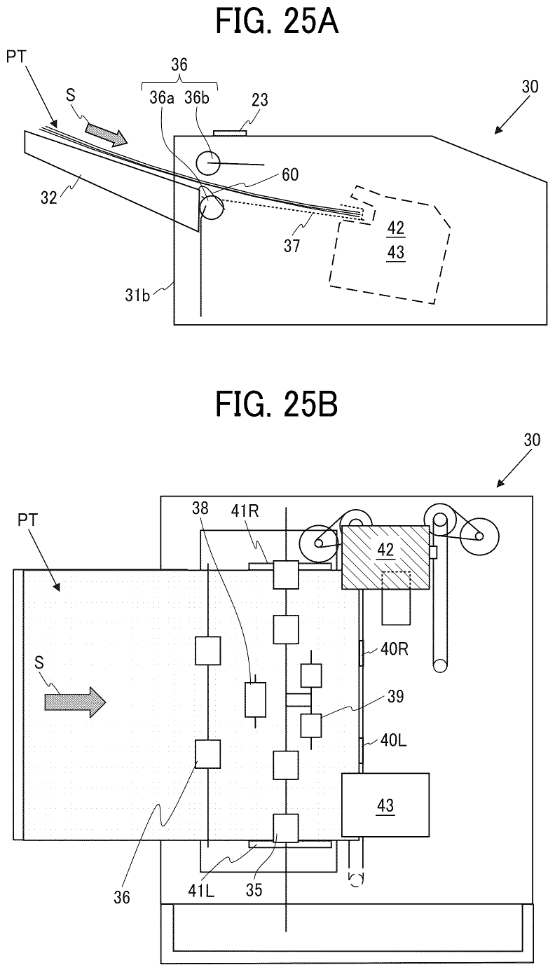

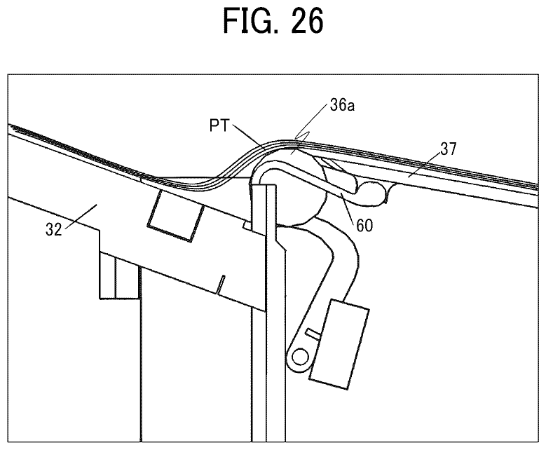

FIG. 18, FIG. 19, FIG. 20, FIG. 21, FIG. 22, FIG. 23, FIG. 24, FIG. 25, and FIG. 26 are diagrams each of which illustrates a configuration of the guide 60 and how the guide 60 moves according to the first example and the second example.

FIG. 18 is a diagram illustrating a driving unit to move the second output tray 32.

The second output tray 32 is moved upward or moved downward by the driving unit illustrated in FIG. 18. As illustrated in FIG. 18, the second output tray 32 is coupled to a tray lifting and lowering belt 642 by a tray lifting and lowering belt coupler 644. In order to lift the second output tray 32, the tray lifting and lowering motor 641 is driven to rotate in a clockwise direction in FIG. 18. Accordingly, the tray lifting and lowering belt 642 and a tray lifting and lowering pulley 643 rotate in a clockwise direction, and the second output tray 32 moves upward. In order to move the second output tray 32 downward, the tray lifting and lowering motor 641 is driven to rotate in a counterclockwise direction in FIG. 18. Accordingly, the tray lifting and lowering belt 642 and a tray lifting and lowering pulley 643 rotate in a counterclockwise (CCW) direction, and the second output tray 32 moves downward.

FIG. 19 is a diagram illustrating an initial position of the second output tray 32.

The tray up-and-down movement sensor 645 is supported in a pivotable manner around a sensor rotary shaft 647, and is pressed against the housing wall 31b by a tray pressing member 648 on a constant basis. As the sheet surface sensor 646 detects that the tray up-and-down movement sensor 645 has contacted the second output tray 32 or the uppermost face of the sheets P stacked on the second output tray 32, the position of the second output tray 32 is detected.

FIG. 20 indicates a state in which the position of the second output tray 32 or the uppermost face of the sheets P stacked on the second output tray 32 is not detected by the sheet surface sensor 646.

When none of the above is detected by the sheet surface sensor 646, the tray up-and-down movement sensor 645 contacts the housing wall 31b. After the second output tray 32 is moved upward to a position detectable by the sheet surface sensor 646, the second output tray 32 is moved upward to a position detectable by the sheet surface sensor 646. When detection has been made by the sheet surface sensor 646, after the second output tray 32 is moved downward to a position not detectable by the sheet surface sensor 646, the second output tray 32 is moved upward to a position detectable by the sheet surface sensor 646. By so doing, initialization to return the second output tray 32 to the default position is done.

FIG. 21 is a diagram illustrating the output tray manual binding sensor 649.

FIG. 22 is a diagram illustrating a standby position of the second output tray 32 for manual binding.

When manual binding is to be performed, the manual binding mode key 23 is operated to start the manual binding mode. After the manual binding mode starts, the post-processing controller 160 rotates the tray lifting and lowering motor 641 to lift the tray lifting and lowering belt coupler 644 that engages the tray lifting and lowering belt 642 with the second output tray 32. The tray lifting and lowering belt coupler 644 has a protruding portion, and the second output tray 32 is moved upward to a point where the output tray manual binding sensor 649 detects that protruding portion. Such a tray stop position is a standby position before manual binding is performed.

FIG. 23 is a diagram illustrating the position of a sensor when the second output tray 32 is lifted.

When the second output tray 32 is lifted, as illustrated in FIG. 23, the tray up-and-down movement sensor 645 retracts inside the housing wall 31b, and contacts an upstream portion of the second output tray 32.

FIG. 24A and FIG. 24B are diagrams illustrating the position of the guide 60 when the second output tray 32 is lifted by a lifting and lowering driver.

When the second output tray 32 is moved upward, the top face of the guide 60 is stopped at a position higher than the height of a downstream portion of the internal tray 37 as the upper limit of movement. The second output tray 32 is also stopped at a position higher than the height of a downstream portion of the internal tray 37 as the upper limit of movement.

Around an upstream end of the second output tray 32 where the guide 60 contacts the second output tray 32, a step 32a is formed below the sheet table of the second output tray 32. As the second output tray 32 moves upward, the front end of the guide 60 contacts the step 32a, and the guide 60 pivots upward. An uppermost portion of the top face of the guide 60 is a curved plane when the guide 60 is at the first position, and such a curved plane can prevent the sheet P from getting caught when the sheet P is inserted.

Due to the above configurations, the sheet P can be inserted along the second output tray 32 when manual binding is performed. The sheet P can be inserted along the curved surface of the guide 60, and the sheet P can easily be inserted without contacting the drive ejection roller 36a.

FIG. 25A is a side view of the post-processing apparatus 30 when the sheet bundle PT is inserted.

FIG. 25B is a top view of the post-processing apparatus 30 when the sheet bundle PT is inserted.

After the second output tray 32 has moved to a position higher than the drive ejection roller 36a of the conveyance roller pair 36, a prompt to insert the sheets P is displayed on the operation panel 149 (see FIG. 1).

Subsequently, a user inserts the sheet bundle PT of a desired number of sheets into the internal tray 37 through the opening 31a. In so doing, the sheet bundle PT is inserted along the second output tray 32 when the second output tray 32 is at a position higher than the drive ejection roller 36a. Accordingly, the front end of the sheet bundle PT is guided by the guide 60, and the sheet bundle PT can easily be inserted. After the sheet bundle PT is inserted, the manual binding mode key 23 is touched or pressed down or the screen of the manual binding mode that is displayed on the operation panel 149 is touched or clicked. Accordingly, the sheet P is automatically bound by the crimp binding device 42 or the stapler 43.

FIG. 26 illustrates how the second output tray 32 moves downward after binding is performed.

After the binding is performed, the manual binding mode key 23 is touched or pressed down or an image displayed on the operation panel 149 to indicate that the manual binding mode is completed is touched or clicked. Accordingly, the second output tray 32 is moved downward by the tray lifting and lowering motor 641, and the second output tray 32 is moved downward until the sheet surface sensor 646 is turned off. Subsequently, the second output tray 32 moves upward to a detecting position, and as illustrated in FIG. 19, returns to the initial position. A system may be adopted in which the second output tray 32 automatically moves downward without touching or pressing down manual binding mode key 23 after the binding is completed. Such a switching between an automatic mode and a manual mode may be edited or adjusted as desired through the operation panel 149. As the second output tray 32 is moved downward, space is created at the opening 31a, and a user can pick up the sheet P easily.

### THIRD EXAMPLE

The post-processing apparatus 30 according to the third example is described below.

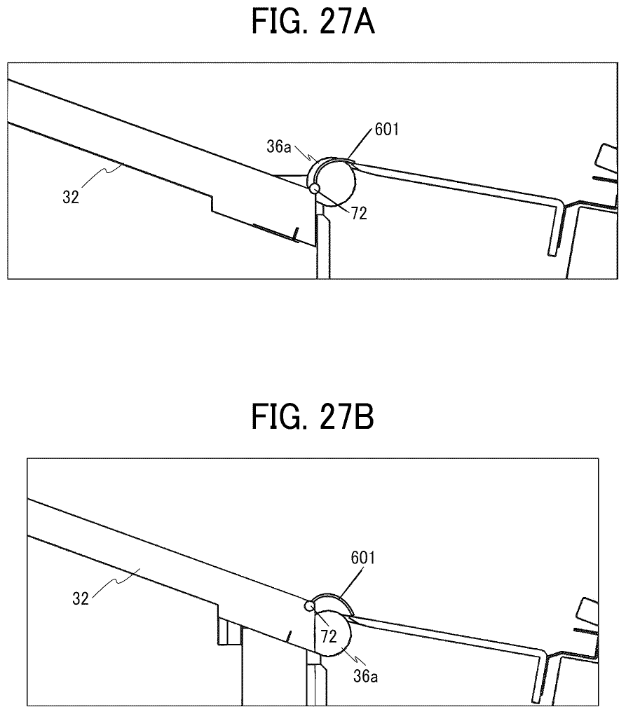

In the present example, as illustrated in FIG. 27A and FIG. 27B, a second guide 601 that moves back and forth so as to cover the top face of the drive ejection roller 36a is located at an upstream portion of the second output tray 32. The second guide 601 has a curved surface that guides the sheet bundle PT. One end of such a curved surface is attached to the second output tray 32 in a pivotable manner, and the other end of such a curved surface contacts the top face of the internal tray 37. The internal tray 37 may have a concave portion formed on its surface, and the other end of the curved surface of the second guide 601 may retract inside such a concave portion. In a similar manner to the examples as described above, when the second guide 601 is at a retracted position, the second guide 601 does not project from the outer round surface of the conveyance roller pair 36.

When the second output tray 32 moves upward, the second guide 601 pivots around a rotary shaft 72 that serves as a fulcrum, and moves to a point above the top face of the drive ejection roller 36a. Accordingly, the sheet bundle PT moves along the second guide 601 when the sheet bundle PT is inserted.

### FOURTH EXAMPLE

The post-processing apparatus 30 according to the fourth example is described below.

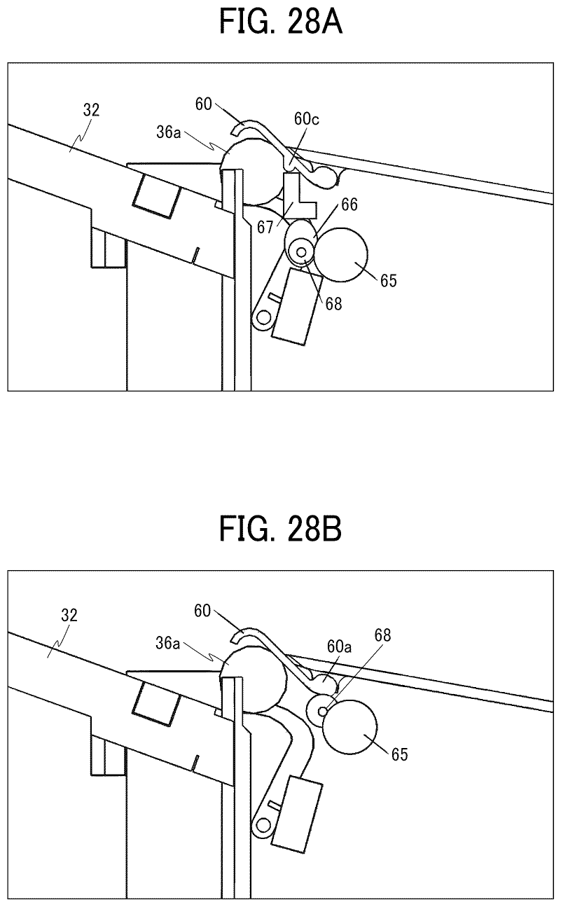

As illustrated in FIG. 28A, the lifting and lowering movement of the guide 60 may be implemented by a guide lifting and lowering mechanism with a cam. As illustrated in FIG. 28B, the lifting and lowering movement of the guide 60 may be implemented by a mechanism with a gear driven to rotate by a motor. Another example of the lifting and lowering driver is described below with reference to FIG. 28A, and a contact portion 60 c is provided for the guide 60 in such an example. A guide lifting and lowering motor 65, a gear 68, a cam 66, and an L-shaped lifting and lowering unit 67 are provided, and the guide lifting and lowering motor 65 is driven to rotate to rotate the cam 66. Then, the cam 66 lifts up the L-shaped lifting and lowering unit 67. The guide 60 is moved up and down as the L-shaped lifting and lowering unit 67 contacts the contact portion 60c of the guide 60.

As illustrated in FIG. 28B, a lifting and lowering unit may be omitted. For example, a system may be adopted in which gear teeth are formed on the guide shaft 60a, the guide lifting and lowering motor 65 and the gear 68 are provided, and the guide 60 is directly driven to rotate. In such a configuration, the amount of ascent and descent can be adjusted easily by controlling the rotation amount.

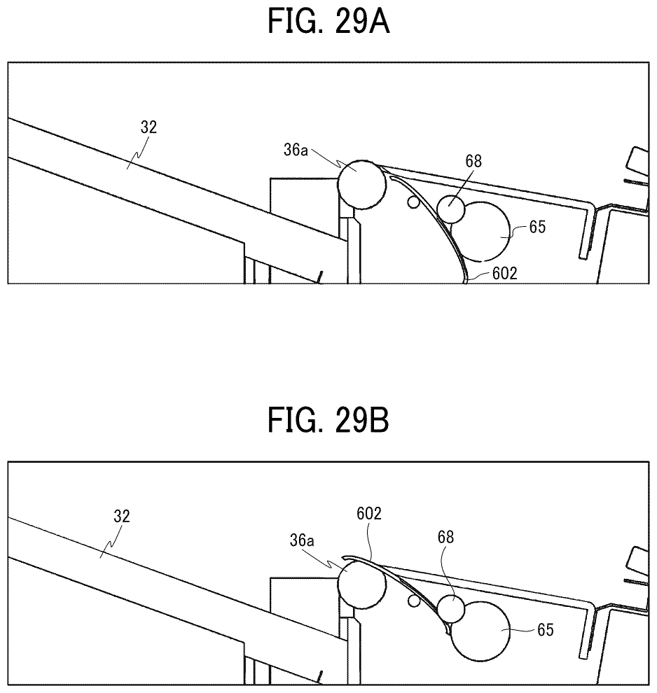

As illustrated in FIG. 29A and FIG. 29B, the slide guide 602 may stick out downward with reference to the second output tray 32. An upstream portion of the slide guide 602 has a gear-shaped top face, and the guide lifting and lowering motor 65 is driven to rotate to enable the loading and unloading operation of the slide guide 602. FIG. 29A illustrates a retracted position of the slide guide 602, and FIG. 29B illustrates the position of the slide guide 602 when the sheet bundle PT is manually fed.

Also in the present example, when the slide guide 602 is at a retracted position, the slide guide 602 does not project from the outer round surface of the conveyance roller pair 36. Due to this configuration, collision can be prevented when the conveyance roller pair 36 ejects the sheet bundle PT. By contrast, when the sheet bundle PT is manually fed, the slide guide 602 is located above the outer round surface of the conveyance roller pair 36. Due to this configuration, the sheet bundle PT can be inserted along the slide guide 602.

### FIFTH EXAMPLE

The post-processing apparatus 30 according to the fifth example is described below.

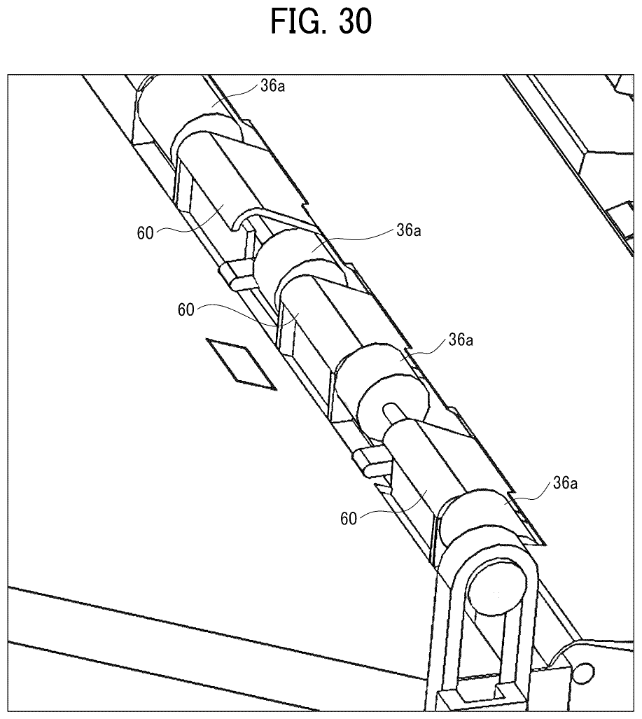

FIG. 30 illustrates the arrangement of the guides 60 when four rollers are provided as the drive ejection roller 36a.

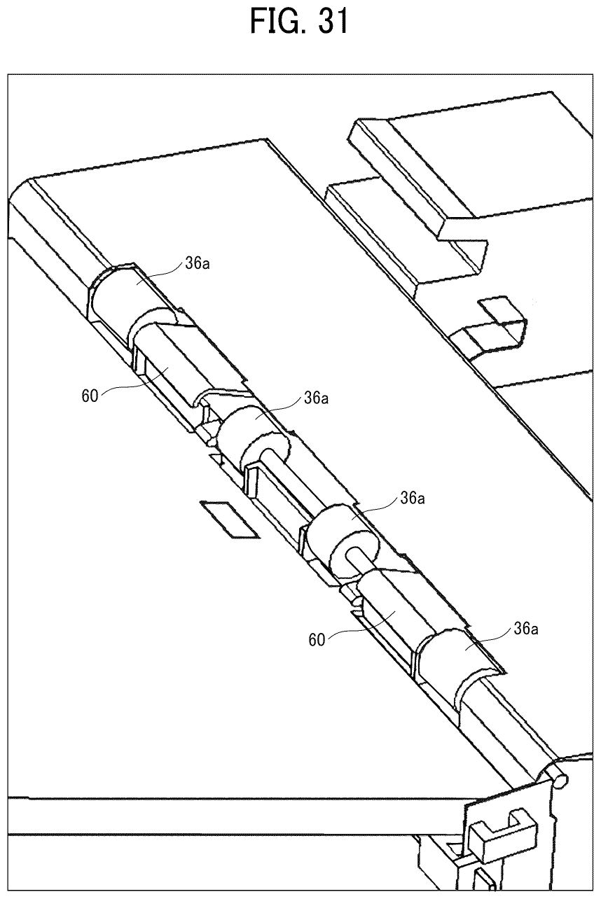

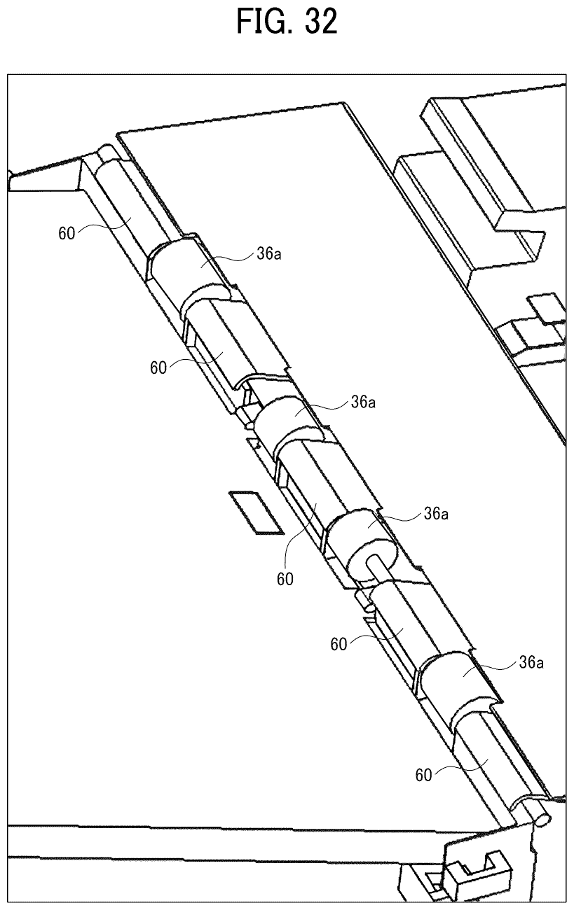

In FIG. 30, the guide 60 is located between each pair of the drive ejection rollers 36a. In FIG. 31, cases in which four rollers are provided as the drive ejection roller 36a are illustrated, and the guide 60 between the pair of the drive ejection rollers 36a in the middle is omitted instead of arranging the guide 60 at all the intervals between each pair of the drive ejection rollers 36a. In FIG. 32, the guides 60 may be located at positions external to the pair of the drive ejection rollers 36a on both ends in a direction intersecting with the ejection direction.

In all the examples described above with reference to FIG. 30, FIG. 31, and FIG. 32, the guide 60 may be located between a pair of rollers of the drive ejection rollers 36a, and the post-processing apparatus 30 can be implemented with reduced space.

### SIXTH EXAMPLE

The guide 60 applicable to the post-processing apparatus 30 according to the sixth example is described below.

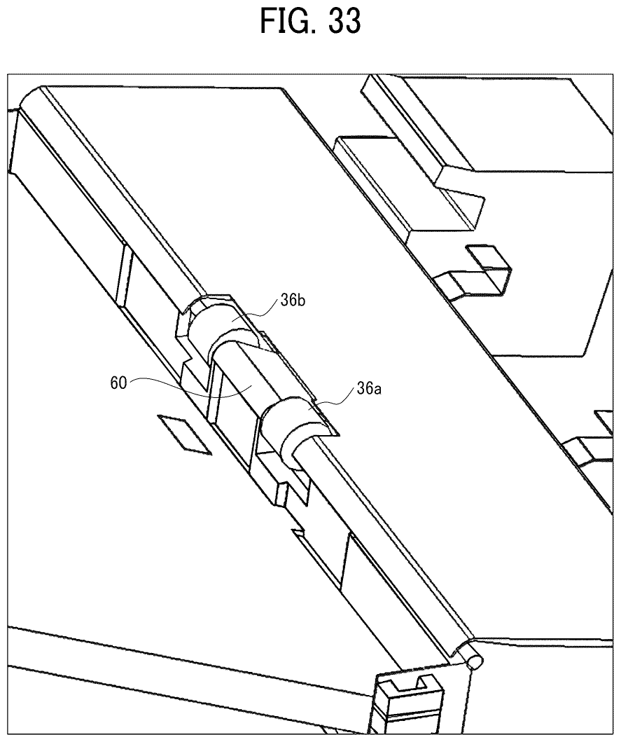

FIG. 33 illustrates the arrangement of the guides 60 when two rollers are provided as the drive ejection roller 36a.

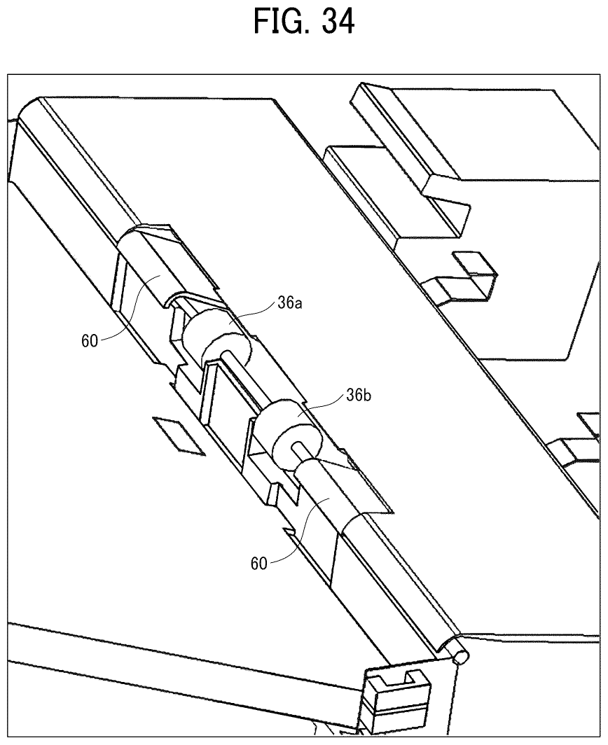

In a similar manner to cases in which four rollers are provided as the drive ejection roller 36a are illustrated, as illustrated in FIG. 33, the guide 60 may be provided between the pair of the drive ejection rollers 36a when two rollers are provided as the drive ejection roller 36a. As illustrated in FIG. 34, the guide 60 may be located in areas external to the rollers.

### SEVENTH EXAMPLE

The post-processing apparatus 30 according to the seventh example is described below.

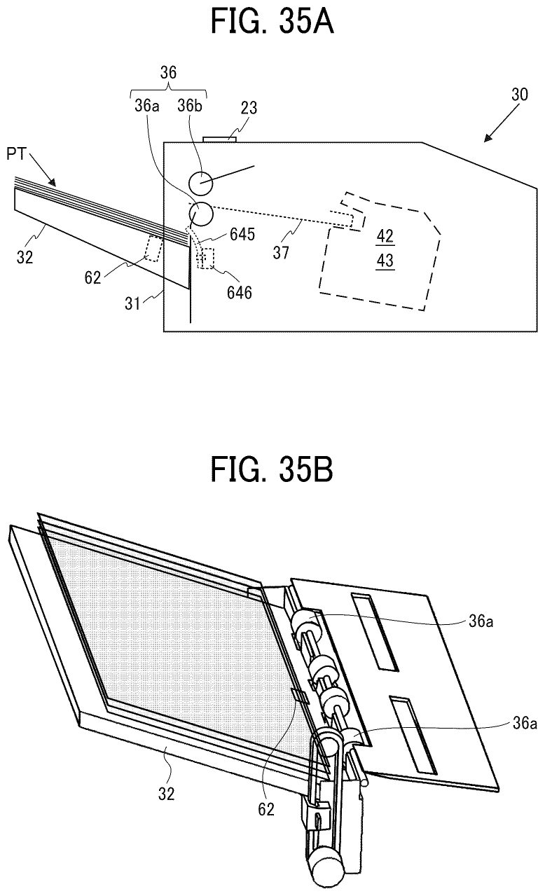

FIG. 35A and FIG. 35B are diagrams illustrating the operation of the second output tray 32 when the sheets P are stacked on the second output tray 32.

In the present example, the second output tray 32 is provided with an output tray sheet sensor 62 of reflection type on its sheet table.

As the output tray sheet sensor 62 detects the sheet P, a program that is executed by the post-processing controller 160 can detect that the sheet P or the sheet bundle PT is stacked on the second output tray 32. In so doing, the tray up-and-down movement sensor 645 contacts the top one of the sheets P of the sheet bundle PT stacked on the second output tray 32, and the second output tray 32 stops moving at the detecting position of the sheet surface sensor 646.

When the manual binding mode key 23 is touched or pressed down when the sheet P or the sheet bundle PT that has been ejected is stacked on the second output tray 32, the operation panel 149 is instructed to display a message that prompts a user to pick up the sheet bundle PT that is stacked on the second output tray 32 is picked up. After the sheet bundle PT that is stacked on the second output tray 32 is picked up and the output tray sheet sensor 62 no longer detects the sheet bundle PT, the post-processing controller 160 moves the second output tray 32 upward to the default position.

### First Example of Program Executable by Post-Processing Apparatus 30

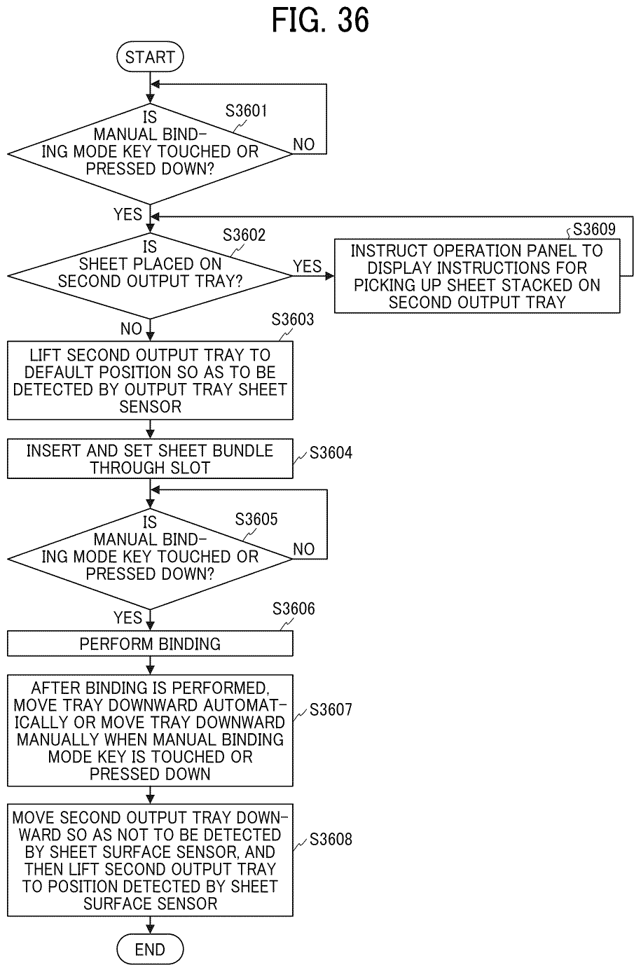

Some processes of the manual binding executable by the post-processing apparatus 30 are described below with reference to the flowchart of FIG. 36. As will be described later, the manual binding by the post-processing apparatus 30 is implemented by executing the software that is executed by the post-processing controller 160 using the hardware resources of the post-processing apparatus 30.

Firstly, as illustrated in FIG. 36, in step S3601, the post-processing controller 160 determines whether the manual binding mode key 23 is touched or pressed down. The processes loop until the manual binding mode key 23 is touched or pressed down (NO in step S3601). When it is detected that the manual binding mode key 23 is touched or pressed down (YES in step S3601), in step S3602, the post-processing controller 160 determines whether the output tray sheet sensor 62 has detected that the sheet P or the sheet bundle PT is placed on the sheet table of the second output tray 32. When the output tray sheet sensor 62 has detected the sheet P or the sheet bundle PT (YES in step S3602), in step S3609, the post-processing controller 160 instructs the operation panel 149 to display an image to gives notification of instructions for picking up the sheet P or the sheet bundle PT stacked on the second output tray 32 through the image-formation controller 150. The loop of the processes in step S3602 and step S3609 is continued until the output tray sheet sensor 62 no longer detects the sheet P or the sheet bundle PT.

When the output tray sheet sensor 62 does not detect the sheet P or the sheet bundle PT (NO in step S3602), in step S3603, the post-processing controller 160 lifts the second output tray 32 to the default position.

Subsequently, in step S3604, the sheet bundle PT that is an object to be manually bound is inserted and set through the opening 31a. Subsequently, in step S3605, the post-processing controller 160 determines whether the manual binding mode key 23 is touched or pressed down. The processes loop until the manual binding mode key 23 is touched or pressed down (NO in step S3605). When it is detected that the manual binding mode key 23 is touched or pressed down (YES in step S3605), the post-processing controller 160, in step S3606, a suitable kind of binding that is selected from the preset types of binding is performed. In step S3606, for example, crimp binding (stapleless binding) or stapling is executable.

After the binding is performed in step S3606, in step S3607, the post-processing controller 160 moves the second output tray 32 downward so as not to be detected by the sheet surface sensor 646. Then, in step S3608, the post-processing controller 160 lifts the second output tray 32 to a position detected by the sheet surface sensor 646.

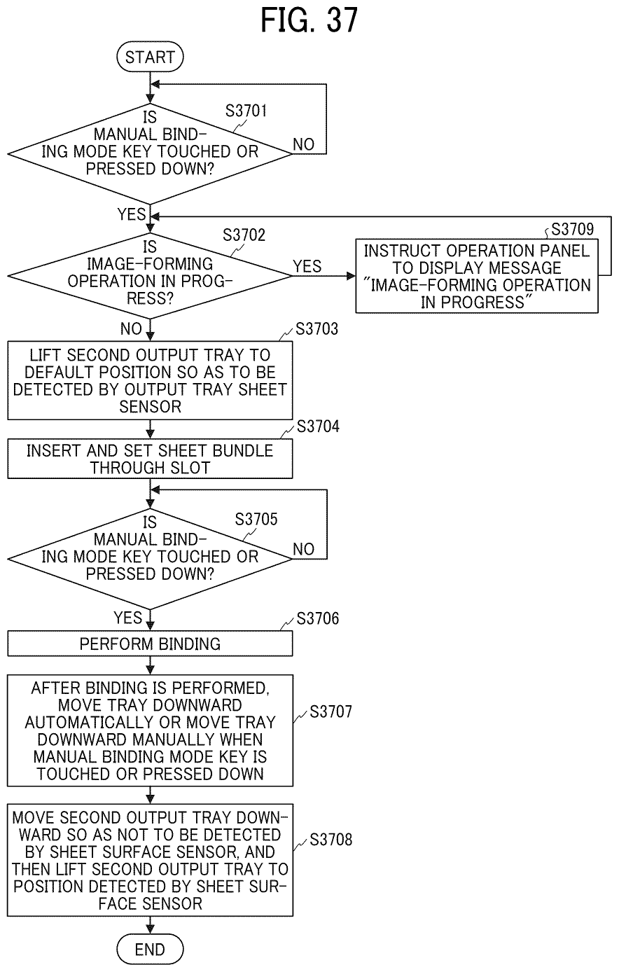

Some other processes of the manual binding executable by the post-processing apparatus 30 are described below with reference to the flowchart of FIG. 37. The flowchart illustrated in FIG. 37 is different from the flowchart of the first example as described above with reference to FIG. 36 in the processes in step S3702. Such differences will be described below in detail, but some equivalent steps may be described in a simplified manner.

In step S3701, the post-processing controller 160 determines whether the manual binding mode key 23 has been touched or pressed down, and the processes loop until the manual binding mode key 23 is touched or pressed down (NO in step S3701). When it is detected that the manual binding mode key 23 is touched or pressed down (YES in step S3701), in step S3702, the post-processing controller 160 determines whether instructions to execute an image-forming operation have been given from the image forming apparatus 100, which is a host device, to the post-processing apparatus 30 through the image-formation controller 150. When it is determined in step S3702 that such instructions have been given, it is determined that the image-forming operation by the image forming apparatus 100 is in progress. In other words, when it is determined in step S3702 that the image-forming operation by the image forming apparatus 100 is in progress (YES in step S3702), in step S3709, the post-processing controller 160 instructs the operation panel 149 through the image-formation controller 150 to display an image indicating a condition that the manual binding cannot be executed because an image-forming operation is in progress. Until the image-forming operation is completed, the loop of the processes in step S3702 and step S3709 is continued.

When it is determined that an image-forming operation is not in progress (NO in step S3702), in step S3703, the post-processing controller 160 lifts the second output tray 32 to the default position. The following processes in steps S3703 to S3708 are equivalent to the processes in steps S3603 to S3608.

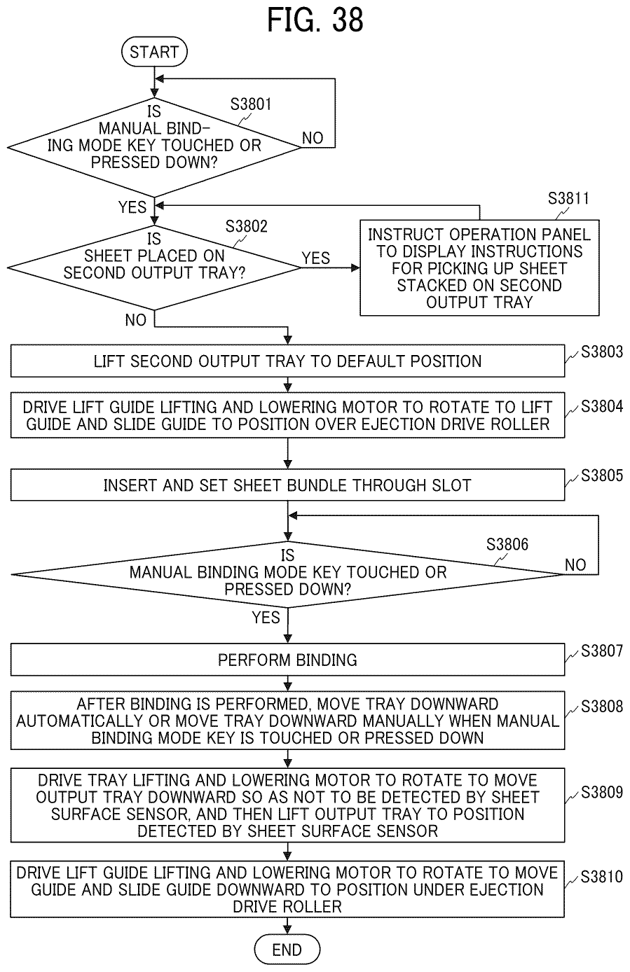

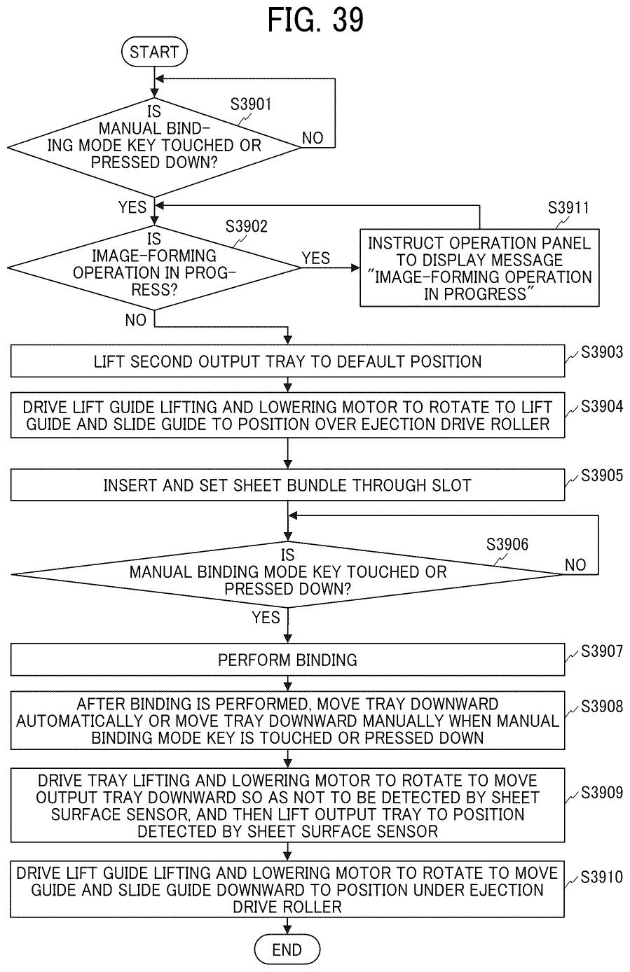

Some other processes of the manual binding executable by the post-processing apparatus 30 are described below with reference to the flowchart of FIG. 38. Some of the processes in the flowchart illustrated in FIG. 39 are equivalent to the processes in the flowchart of the first example as described above with reference to FIG. 36. For this reason, differences are mainly described, and some equivalent steps may be described in a simplified manner.

As illustrated in FIG. 38, in step S3801, the post-processing controller 160 determines whether the manual binding mode key 23 is touched or pressed down. The processes loop until the manual binding mode key 23 is touched or pressed down (NO in step S3801). When it is detected that the manual binding mode key 23 is touched or pressed down (YES in step S3801), in step S3802, the post-processing controller 160 determines whether the output tray sheet sensor 62 has detected that the sheet P or the sheet bundle PT is placed on the sheet table of the second output tray 32. When the output tray sheet sensor 62 has detected the sheet P or the sheet bundle PT (YES in step S3802), in step S3811, the post-processing controller 160 instructs the operation panel 149 to display an image to gives notification of instructions for picking up the sheet P or the sheet bundle PT stacked on the second output tray 32 through the image-formation controller 150. The processes in step S3802 and step S3811 loop until the output tray sheet sensor 62 no longer detects the sheet P or the sheet bundle PT.

When the output tray sheet sensor 62 does not detect the sheet P or the sheet bundle PT (NO in step S3802), in step S3803, the post-processing controller 160 lifts the second output tray 32 to the default position.

Subsequently, in step S3804, the post-processing controller 160 drives the guide lifting and lowering motor 65 to rotate to lift the guide 60 and the slide guide 602 to a position over the drive ejection roller 36a. In step S3805, the sheet bundle PT to be manually bound is inserted and set through the opening 31a. Subsequently, in step S3806, the post-processing controller 160 determines whether the manual binding mode key 23 is touched or pressed down. The processes loop until the manual binding mode key 23 is touched or pressed down (NO in step S3806). When it is detected that the manual binding mode key 23 is touched or pressed down (YES in step S3806), in step S3807, the post-processing controller 160 performs the binding based on the preset types of binding. In step S3807, for example, crimp binding (stapleless binding) or stapling is executable.

After the binding is performed in step S3807, in step S3808, the post-processing controller 160 moves the second output tray 32 downward. After the binding is performed in step S3807, in step S3808, the downward movement of the second output tray 32 may be started in response to a trigger that the manual binding mode key 23 is touched or pressed down.

Subsequently, in step S3809, the post-processing controller 160 drives the tray lifting and lowering motor 641 to rotate to move the second output tray 32 downward so as not to be detected by the sheet surface sensor 646, and then lift the second output tray 32 to a position detected by the sheet surface sensor 646.

Subsequently, in step S3810, the post-processing controller 160 drives the guide lifting and lowering motor 65 to rotate to lower the guide 60 and the slide guide 602 to a position under the drive ejection roller 36a.

Fourth Example of Control Processes Executable by Post-processing Apparatus

Some other processes of the manual binding executable by the post-processing apparatus 30 are described below with reference to the flowchart of FIG. 39. The flowchart illustrated in FIG. 39 is different from the flowchart of the third example as described above with reference to FIG. 38 in the processes in step S3902. Such differences will be described below in detail, but some equivalent steps may be described in a simplified manner.

In step S3901, the post-processing controller 160 determines whether the manual binding mode key 23 is touched or pressed down, and the processes loop until the manual binding mode key 23 is touched or pressed down (NO in step S3901). When it is detected that the manual binding mode key 23 is touched or pressed down (YES in step S3901), in step S3902, the post-processing controller 160 determines whether instructions to execute an image-forming operation have been given from the image forming apparatus 100, which is a host device, to the post-processing apparatus 30 through the image-formation controller 150. When it is determined in step S3902 that such instructions have been given, it is determined that the image-forming operation by the image forming apparatus 100 is in progress. In other words, when it is determined in step S3702 that the image-forming operation by the image forming apparatus 100 is in progress (YES in step S3902), in step S3911, the post-processing controller 160 instructs the operation panel 149 through the image-formation controller 150 to display an image indicating a condition that the manual binding cannot be executed because an image-forming operation is in progress. Until the image-forming operation is completed, the loop of the processes in step S3902 and step S3911 is continued.

When it is determined that an image-forming operation is not in progress (NO in step S3902), in step S3903, the post-processing controller 160 lifts the second output tray 32 to the default position. The following processes in steps S3903 to S3910 are equivalent to the processes in steps S3803 to S3810.

In all the examples of control processes as described above, the manual binding mode may automatically be ended when no manipulation is made for a length of time equal to or longer than any desired present length of time after the sheet P is set. In such a configuration, a desired length of time is set through the operation panel 149 of the image forming apparatus 100.

### Fifth Example of Control Processes Executable by Post-processing Apparatus

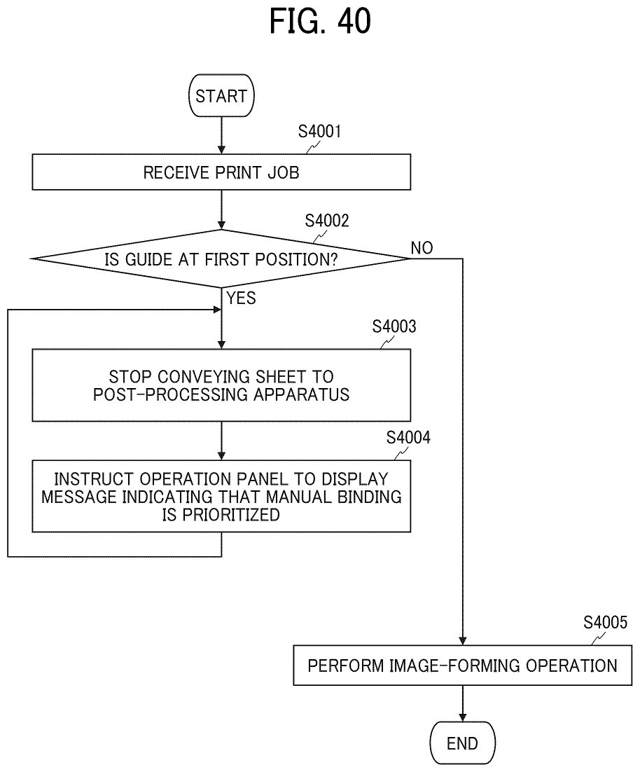

Some other processes of the manual binding executable by the post-processing apparatus 30 are described below with reference to the flowchart of FIG. 40.

Basically, in the post-processing apparatus 30, binding is performed on the sheet bundle PT composed of the sheets P that are conveyed from an external device including the image forming apparatus 100, and then the sheet bundle PT is ejected. However, no limitation is indicated thereby, and the sheet bundle PT that is manually fed through the opening 31a may be bound by the post-processing apparatus 30.

In view of the above circumstances, firstly, in step S4001, the post-processing controller 160 receives a print job, and then, in step S4002, the post-processing controller 160 determines whether the guide 60 is at the first position to determine whether the manual binding is being performed. As described above, when the guide 60 is at the first position, the manual binding is being performed by the post-processing apparatus 30.

When the guide 60 is at the first position (YES in step S4002), in step S4003, the post-processing controller 160 sends instructions to the image-formation controller 150 to stop conveying the sheet P to the post-processing apparatus 30. In step S4003, the post-processing controller 160 may send instructions to the image-formation controller 150 to stop an image-forming operation. Alternatively, in step S4003, the post-processing controller 160 may send instructions to the image-formation controller 150 to execute an image-forming operation but to stop the conveyance to the post-processing apparatus 30.

Subsequently, in step S4004, the post-processing controller 160 instructs the operation panel 149 to display a message indicating that manual binding is prioritized through the image-formation controller 150.

When the guide 60 is not at the first position in step S4002, in step S4005, an image-forming operation is performed, and the sheet P is conveyed to the post-processing apparatus 30.

According to the post-processing apparatus 30 as described above, when binding is to be performed on the sheet bundle PT composed of the sheets P that are conveyed and stacked, the guide 60 retracts to a position lower than the top face of the conveyance roller pair 36 that is an example of an output roller pair so as not to disturb the ejection of the sheets P. When the sheet bundle PT is manually fed through the opening 31a for binding, the guide 60 moves upward to a point above the top face of the drive ejection roller 36a that makes up the conveyance roller pair 36 that is an example of an output roller pair. Accordingly, the sheet bundle PT that is manually fed is prevented from contacting the drive ejection roller 36a. Accordingly, the sheet bundle PT can be inserted through the opening 31a with greater customer convenience.

Aspects of the present disclosure are, for example, as follows.

The above-described examples of manual binding are applicable to a finisher of console type attached to the side of the image forming apparatus 100. In a similar manner to the above-described examples, the sheet bundle PT is inserted through the opening 31a and the manual binding mode key 23 is touched or pressed down to perform binding.

When the post-processing apparatus 30 as described above corresponds to the image forming system 300 described above with reference to FIG. 4, the manual binding is implemented by executing software that is executed by the image-formation controller 150 provided for the image forming apparatus 100. In other words, the above-described control processes of the manual binding using the hardware resources provided for the post-processing apparatus 30 are implemented by software that is executed by the image-formation controller 150.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The above-described processes may be implemented by, for example, a program. In other words, the above-described processes may be implemented as the CPU 151 or the CPU 161, which is an example of a processor, executes a program stored in the memory 152 or the memory 162. The program is not limited to a single program, and may be a collection or combination of a plurality of programs. The program is not necessarily executed by one of the CPU 151 and the CPU 161, but may be executed by both the CPU 151 and the CPU 161 in a divided manner. The program may be written in, for example, a storage device or a storage medium and distributed with the storage device or the storage medium, or may be distributed through, for example, a telecommunication line.

Aspects of the present disclosure are, for example, as follows.

### First Aspect

A sheet processing apparatus includes a temporary stacker on which a plurality of sheets are stacked on a temporary basis, a sheet processing device to perform given processing on a sheet bundle including the plurality of sheets stacked on the temporary stacker, an ejection device including a pair of rotors to eject the sheet bundle, and a guide movable between a first position above a top face of lower one of the pair of rotors and a second position below the top face of the lower one of the pair of rotors.

### Second Aspect

In the sheet processing apparatus according to the first aspect, the first position is at a position higher than the temporary stacker.

### Third Aspect

In the sheet processing apparatus according to the first aspect or the second aspect, the second position is a position inner than a downstream end of the lower one of the pair of rotors in a sheet ejection direction.

### Fourth Aspect

In the sheet processing apparatus according to any one of the first to third aspects, the guide is at the first position when the sheet bundle is inserted toward the temporary stacker through the ejection device.

### Fifth Aspect

In the sheet processing apparatus according to any one of the first to fourth aspects, a sheet-bundle stacker on which the sheet bundle ejected by the ejection device is stacked and a lifting and lowering driver to lift or lower the sheet-bundle stacker are further provided. The guide switches between the first position and the second position as the sheet-bundle stacker is lifted or lowered.

### Sixth Aspect

In the sheet processing apparatus according to the fifth aspect, an upper limit of movement of the sheet-bundle stacker by the lifting and lowering driver is at a position above a sheet table of the temporary stacker.

### Seventh Aspect

In the sheet processing apparatus according to the fifth aspect or the sixth aspect, a guide lifting and lowering device to lift or lower the guide is further provided, and the guide is switched between the first position and the second position by the guide lifting and lowering device.

### Eighth Aspect

In the sheet processing apparatus according to any one of the fifth to seventh aspects, the guide contacts the sheet-bundle stacker on a plane lower than a sheet table of the sheet-bundle stacker.

### Ninth Aspect

In the sheet processing apparatus according to any one of the first to eighth aspects, the guide has a curved face at an uppermost portion when the guide is at the first position.

### Tenth Aspect

In the sheet processing apparatus according to any one of the first to ninth aspects, the guide is disposed at a position different from a position of the lower one of the pair of rotors.

### Eleventh Aspect

An image forming system includes an image forming apparatus to form an image on a sheet and the sheet processing apparatus according to any one of the first to tenth aspects, and the sheet processing apparatus performs given processing on the sheet.

### Twelfth Aspect

An image forming system includes an image forming device to form an image on a sheet, a sheet processing apparatus on which the sheet that has passed through the image forming device is stacked to perform given processing on the stacked sheet, a sheet ejection unit including a pair of rotors to eject the sheet processed by the sheet processing apparatus, and a guide to move to a first position above a top face of lower one of the pair of rotors and a second position below the top face of the lower one of the pair of rotors. When the guide is at the first position and instructions are given to execute an image-forming operation by the image forming device, the image-forming operation or conveyance to the sheet processing apparatus is terminated.

### Thirteenth Aspect

A non-transitory recording medium stores a plurality of instructions which, when executed by one or more processors of a sheet processing apparatus, causes the one or more processors to perform a method, and the sheet processing apparatus includes an image forming device to form an image on a sheet, a sheet processing apparatus on which the sheet that has passed through the image forming device is stacked to perform given processing on the stacked sheet, a sheet ejection unit including a pair of rotors to eject the sheet processed by the sheet processing apparatus, and a guide to move to a first position above a top face of lower one of the pair of rotors and a second position below the top face of the lower one of the pair of rotors. When the guide is at the first position and instructions are given to execute an image-forming operation by the image forming device, the image-forming operation or conveyance to the sheet processing apparatus is terminated.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A sheet processing apparatus comprising:
a temporary stacker on which a plurality of sheets are stacked on a temporary basis;
a sheet processing device to perform given processing on a sheet bundle including the plurality of sheets stacked on the temporary stacker;
an ejection device including a pair of rotors to eject the sheet bundle; and
a guide to move between a first position above a top face of lower one of the pair of rotors and a second position below the top face of the lower one of the pair of rotors.

2. The sheet processing apparatus according to claim 1,
wherein the first position is at a position higher than the temporary stacker.

3. The sheet processing apparatus according to claim 1,
wherein the second position is a position inner than a downstream end of the lower one of the pair of rotors in a sheet ejection direction.

4. The sheet processing apparatus according to claim 1,
wherein the guide is at the first position when the sheet bundle is inserted toward the temporary stacker through the ejection device.

5. The sheet processing apparatus according to claim 1, further comprising:
a sheet-bundle stacker on which the sheet bundle ejected by the ejection device is stacked; and
a lifting and lowering driver to lift or lower the sheet-bundle stacker,
wherein the guide switches between the first position and the second position as the sheet-bundle stacker is lifted or lowered.

6. The sheet processing apparatus according to claim 5,
wherein an upper limit of movement of the sheet-bundle stacker by the lifting and lowering driver is at a position above a sheet table of the temporary stacker.

7. The sheet processing apparatus according to claim 5, further comprising
a guide lifting and lowering device to lift or lower the guide,
wherein the guide is switched between the first position and the second position by the guide lifting and lowering device.

8. The sheet processing apparatus according to claim 5,
wherein the guide contacts the sheet-bundle stacker on a plane lower than a sheet table of the sheet-bundle stacker.

9. The sheet processing apparatus according to claim 1,
wherein the guide has a curved face at an uppermost portion when the guide is at the first position.

10. The sheet processing apparatus according to claim 1,
wherein the guide is disposed at a position different from a position of the lower one of the pair of rotors in a vertical direction.

11. An image forming system comprising:
an image forming apparatus to form an image on a sheet; and
the sheet processing apparatus according to claim 1 to perform given processing on the sheet.

12. An image forming system comprising:
an image forming device to form an image on a sheet;
a sheet processing apparatus on which the sheet that has passed through the image forming device is stacked to perform given processing on the sheet;
a sheet ejection unit including a pair of rotors to eject the sheet processed by the sheet processing apparatus;
a guide to move to a first position above a top face of lower one of the pair of rotors and a second position below the top face of the lower one of the pair of rotors; and
processing circuitry configured to send an instruction to stop an image-forming operation by the image forming device or an instruction to stop conveying the sheet to the sheet processing apparatus when the guide is at the first position and an instruction to execute the image-forming operation by the image forming device is given.

13. A non-transitory recording medium storing a plurality of instructions which, when executed by one or more processors of a sheet processing apparatus, causes the one or more processors to perform a method,
the sheet processing apparatus including
an image forming device to form an image on a sheet,
a sheet processing apparatus on which the sheet that has passed through the image forming device is stacked to perform given processing on the sheet,
a sheet ejection unit including a pair of rotors to eject the sheet processed by the sheet processing apparatus, and
a guide to move to a first position above a top face of lower one of the pair of rotors and a second position below the top face of the lower one of the pair of rotors,
the method comprising
terminating an image-forming operation or conveyance to the sheet processing apparatus when the guide is at the first position and instructions are given to execute the image-forming operation by the image forming device.
